(19) United States
(12) Patent Application Publication
(10) Pub. No.: US 2010/0112168 A1
(43) Pub. Date: May 6, 2010

(54) HARVESTING OIL FROM FATTY MEAT MATERIALS TO PRODUCE LEAN MEAT PRODUCTS AND OIL FOR USE IN BIO-DIESEL PRODUCTION

(75) Inventors: Anthony J.M. Garwood, Mercer Island, WA (US); Nicholas James Garwood, Portland, OR (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: SafeFresh Technologies, LLC, Mercer Island, WA (US)

(21) Appl. No.: 12/520,802

(22) PCT Filed: Dec. 21, 2007
(86) PCT No.: PCT/US07/88719

§ 371 Date: Jan. 12, 2010

Related U.S. Application Data
(60) Provisional application No. 60/871,413, filed on Dec. 21, 2006.

(51) Int. Cl. A23L 1/317

(52) U.S. Cl. 426/480

(57) ABSTRACT

A method and apparatus for separating lean meat and/or fat from lean meat-containing material, including combining a particulate material with fluid carbon dioxide. The material and fluid is introduced into a vessel and is separated into low density and high density fractions. The material from the low density fraction is removed via an outlet and has a higher percentage of fat than the material introduced into the vessel. The material from the high density fraction is removed via an outlet and has a higher percentage of lean meat than the material introduced into the vessel. The vessel can include a centrifuge bowl or an inclined vessel. Separation is achieved via gravity or the application of an artificial force field, such as centrifugal force, to separate particulates high in density from those low in density.

### CROSS-REFERENCES TO RELATED APPLICATIONS

This application claims the benefit of U.S. Provisional Patent Application No. 60/871,314, filed on Dec. 21, 2007, and this application is a continuation-in-part of U.S. patent application Ser. No. 11/911,338, filed on Oct. 11, 2007, which is the U.S. national phase of PCT Application No. PCT/US2006/014261, filed on Apr. 13, 2006, which claims the benefit of U.S. Provisional Patent Application No. 60/671,238, filed on Apr. 13, 2005. All these applications are incorporated herein expressly by reference.

### FIELD OF THE INVENTION

The present invention relates to the separation of ground particles into two groupings of firstly fatty adipose tissue particles and secondly lean beef tissue particles from a primary materials source such as quantities of boneless beef pieces of any normal size. Typically, the primary material boneless beef pieces will comprise a significant proportion of fatty adipose tissue such as between about 25% or less by volume and up to 90% or more of fatty adipose tissue with the balance comprising lean beef. After separation, both the first fatty adipose tissue particles and the second lean beef tissue particles will contain controlled amounts of fat and/or lean meat.

### BACKGROUND

Trimming fat from meat, either by hand or via a machine, inevitably results in cutting some of the more valuable lean meat along with the fat. Typically the “trimmings” are collected and used in sausage production or are rendered. Lean meat comprises predominantly muscle protein although some amounts of fatty adipose tissue are typically present, while fat and tallow comprises predominantly triglycerides of fatty acids with connective tissue, cartilage and collagen and are the predominant constituents of animal fat. The value of lean meat in the trim is low compared to boneless beef having a fat content of 15% by weight, for example. The value of 50% lean meat trim is perhaps on the order of 35 cents per pound compared to perhaps about $1.10 for 85% for boneless lean meat. It is, therefore, desirable to separate the lean meat from the trim while increasing the proportion of lean meat compared to fat.

### SUMMARY

A method and apparatus for separating lean meat and/or fat from lean meat-containing material, including combining a particulate material with fluid carbon dioxide. The material which may have a temperature of about 35 to 39° F., is firstly loaded into a carbon dioxide gas filled hopper and transferred in a continuous stream, along a conduit which is also filled with carbon dioxide gas so as to substantially displace air, to a first grinder barrel, which is filled with carbon dioxide gas, and coarse ground into particles of substantially equal dimensions which will most preferably be of a cylindrical profile (when in an undistorted condition, immediately following the grinding procedure and before contact is made with anything else) having a diameter and also a length of about 1 inch or 25 mm. Air is substantially removed from contacting any surface of the freshly ground particulates by displacing with carbon dioxide gas and the stream of coarse ground particles is then chilled to a controlled temperature of between a low level of 29.5° F. and most preferably not above a high temperature of 31.0° F. The stream of coarse ground beef is then pumped by positive displacement (twin cylinder and piston/plunger style) pump through a second grinder wherein the size of each particle is reduced to about ¼″ in diameter and length. The grinding plate of the grinder will most preferably provide a separation wall between the stream of chilled, coarse ground beef, at which point the second grinding has not occurred, and direct contact of all cut surfaces of each particle with large quantities of liquid carbon dioxide which is arranged to contact the surface of the particles immediately following (and during) the forming of each particle during the grinding and cutting phase. Direct contact of the cut surfaces causes freezing at the surfaces to prevent the freshly ground beef from agglomerating into a larger mass and, therefore, remain as individual particles. Immediately after the severing of each particle following the second grinding the particles of beef are frozen by reducing the temperature to about 0° F. and large quantities of liquid carbon dioxide carry the beef particles in suspension away from the grind plate. The mixture of ground beef and liquid carbon dioxide, in a fluidic condition is then transferred immediately to the separation equipment which separates the fluid into low density and high density fractions. The material from the low density fraction is removed via an outlet and has a higher percentage of fat than the material introduced into the vessel. The material from the high density fraction is removed via an outlet and has a higher percentage of lean meat than the material introduced into the vessel. The method of separation may comprise a cyclone, centrifuge bowl or an inclined vessel or tube. Separation is achieved via gravity or the application of an artificial gravity force field, such as centrifugal force, to separate particulates high in density from those low in density.

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a flow diagram of a method and apparatus in accordance with one embodiment of the present invention;

FIG. 2 is a flow diagram of a method and apparatus in accordance with one embodiment of the present invention;

FIG. 3 is a diagrammatical illustration of apparatus in accordance with one embodiment of the present invention;

FIG. 4 is a diagrammatical illustration of apparatus in accordance with one embodiment of the present invention;

FIG. 5 is a diagrammatical illustration of apparatus in accordance with one embodiment of the present invention;

FIG. 6 is a diagrammatical illustration of apparatus in accordance with one embodiment of the present invention;

FIG. 7 is a diagrammatical illustration of apparatus in accordance with one embodiment of the present invention;

FIG. 8 is a diagrammatical illustration of apparatus in accordance with one embodiment of the present invention;

FIG. 9 is a diagrammatical illustration of apparatus in accordance with one embodiment of the present invention;

FIG. 10 is a diagrammatical illustration of apparatus in accordance with one embodiment of the present invention;

FIG. 10i is a cross-sectional view of the apparatus of FIG. 10 during a step of operation;

FIG. 10ii is a cross-sectional view of the apparatus of FIG. 10 during a step of operation;

FIG. 10iii is a table to depict the operation of the apparatus of FIG. 10;

FIG. 11 is a flow diagram of a method and apparatus in accordance with one embodiment of the present invention;

FIG. 12 is a diagrammatical illustration of apparatus in accordance with one embodiment of the present invention;

FIG. 13 is a diagrammatical illustration of apparatus in accordance with one embodiment of the present invention;

FIG. 14 is a diagrammatical illustration of apparatus in accordance with one embodiment of the present invention;

FIG. 15 is a diagrammatical illustration of apparatus in accordance with one embodiment of the present invention;

FIG. 16 is a diagrammatical illustration of apparatus in accordance with one embodiment of the present invention;

FIG. 17 is a diagrammatical illustration of apparatus in accordance with one embodiment of the present invention;

FIG. 18 is a diagrammatical illustration of apparatus in accordance with one embodiment of the present invention;

FIG. 19 is a diagrammatical illustration of apparatus in accordance with one embodiment of the present invention;

FIG. 20 is a diagrammatical illustration of apparatus in accordance with one embodiment of the present invention;

FIG. 21 is a diagrammatical illustration of apparatus in accordance with one embodiment of the present invention;

FIG. 22 is a flow diagram of a method and apparatus in accordance with one embodiment of the present invention; and

FIG. 23 is a diagrammatical illustration of apparatus in accordance with one embodiment of the present invention.

### DETAILED DESCRIPTION

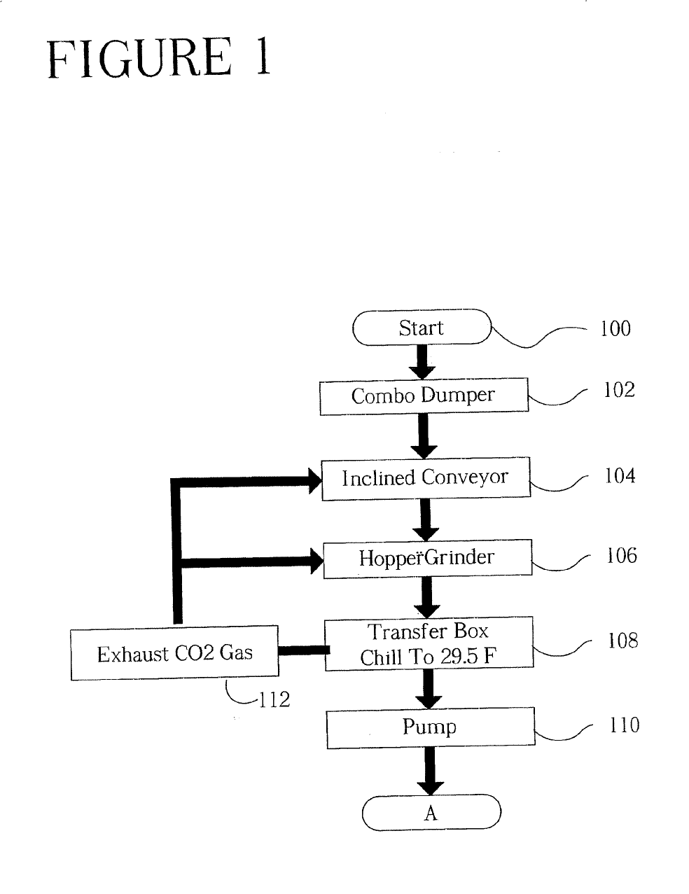

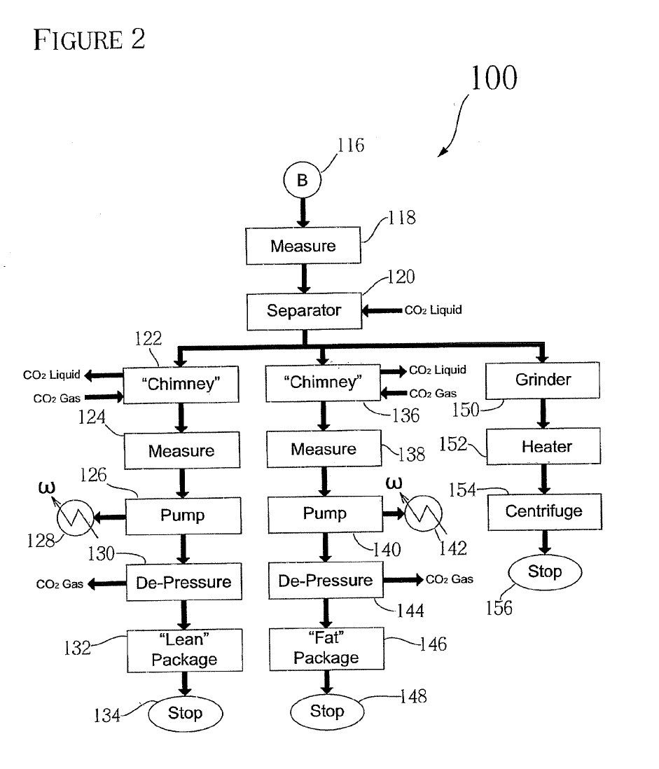

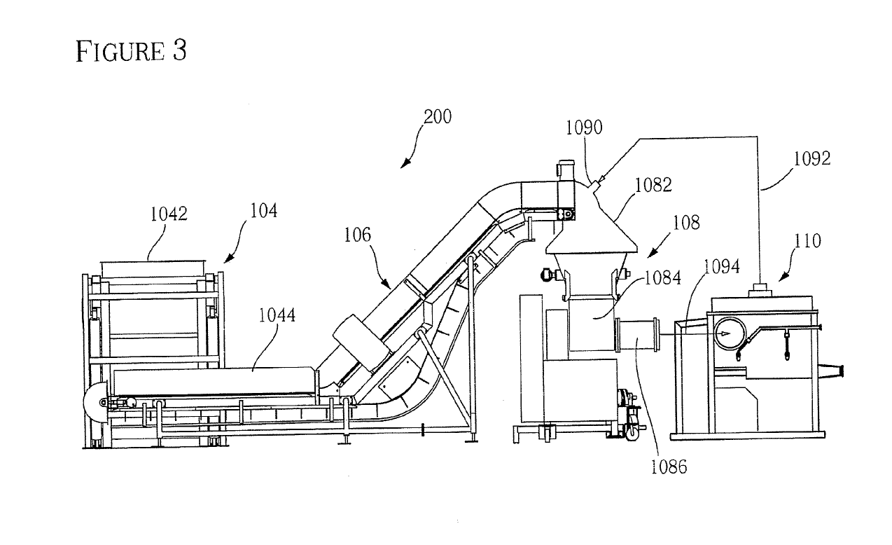

FIGS. 1 and 2 illustrate a representative method in accordance with one embodiment of the present invention. The method commences at start block 100. From start block 100, the method enters block 102. Block 102 represents loading material for the start of a process to separate fat from the material. A combo-dumper includes a device which may include means to seize a container and offload the container onto the conveyor of block 104. The material loaded by the combo-dumper of block 102 can be any material which has a fatty substance that is to be separated to produce products that are high in lean meat and/or low in fat content. A representative combo-dumper is illustrated in FIG. 3.

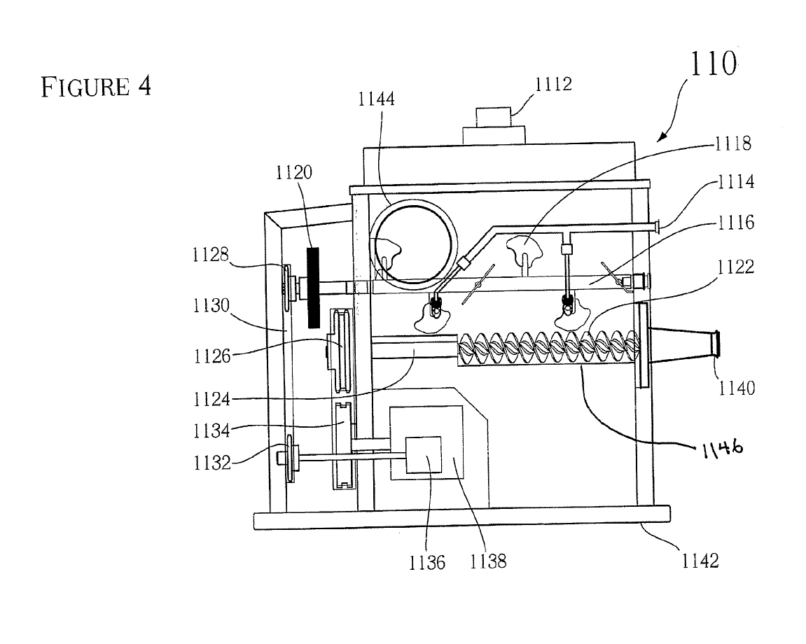

From block 102, the method enters block 104. Block 104 is for conveying the material from the combo-dumper of block 102 to a hopper/grinder apparatus of block 106. A representative conveyor is illustrated in FIG. 3. From block 104, the method enters block 106. Block 106 represents the grinding of the material via a hopper/grinder apparatus. A representative hopper/grinder apparatus is illustrated in FIG. 3. Material is transferred into the hopper from the inclined conveyor, which falls into the grinder bin for grinding into particulates of smaller size as compared to the portions provided in the combo-dumper, block 102. From block 106, the method enters block 108. Block 108 is a transfer box for pre-blending the small particulates of ground material with liquid carbon dioxide. An apparatus for pre-blending is illustrated in FIG. 4. In one embodiment, the transfer box is pressurized and substantially enclosed to provide an atmosphere substantially deficient of oxygen. Pre-blending is performed with carbonic acid, having a pH below 4.9 pH, in an enclosed vessel at an operating pressure from about 300 psi to about 650 psi, and at a varied temperature from about 0° F. to about 34° F., preferably approximately 29.5° F. Gaseous carbon dioxide that is produced from the liquid carbon dioxide can be vented from the transfer box via a hood and can be carried via a vent line to a gaseous carbon dioxide collection system. Liquid carbon dioxide is provided to the transfer box by a liquid carbon dioxide distribution system which will be described in further detail below. Gaseous carbon dioxide that vents from the transfer box block 108, may also be distributed to the hopper/grinder of block 106 or the inclined conveyor of block 104. From block 108, the method enters block 110. Block 110 is for pumping the material from the transfer box block 108 to a measuring device block 118. The pump of block 110 can produce a head pressure of about 600 psi.

In the flow diagram of FIG. 1, continuation block “A” follows pumping block 110. Continuation block “A” signifies that the method is continued on FIG. 2 at block 116. From block 116, the method 100 enters block 118. Block 118 is for measuring the material after pumping, block 112. A suitable measuring instrument is known by the designation Coriolis. A measuring instrument of block 118 can measure any one or all of the fat content, the lean meat content, the water content, and the flow rate being pumped. A suitable measuring instrument may include any device which uses x-rays to scan the material and determine the fat, lean, and/or water content of the material. From block 118, the method 100 enters block 120. Block 120 is for separating the ground material into at least two streams of material. One stream is predominantly lean meat and the other stream is predominantly fat. Various separators are described herein for separation of the material. Separation block 120 uses liquid carbon dioxide as a separating medium which permits ground material to separate into fractions according to the density of the particulates. One embodiment of the separation apparatus includes a settling vessel. Another embodiment includes a centrifuge. Another embodiment includes a hydrocyclone, and yet another embodiment includes an inclined vessel. The ground material is separated into two or more fractions based on the density of each particulate of material, into two or more streams, wherein each separate stream has a different content of fat than the material that was fed into the separator. For example, a first stream of material can comprise mostly fat, while a second stream of material can comprise mostly lean meat. In one embodiment, the content of fat and lean meat can be determined via controllable parameters. The separator of block 120 operates by density differences between particulates of fat and particulates of lean meat. Such materials have varying densities, causing the particulates to stratify according to density in the liquid medium. A preferred medium is liquid carbon dioxide. In addition to serving as the separating medium, liquid carbon dioxide also possesses biocidal properties; thus, simultaneously ensuring sanitizing of the material in block 120. A separator apparatus of block 120 can include apparatus generally termed a “centrifuge,” or, alternatively, the separator of block 120 can include a settling vessel which allows settling of the higher density particulates and collection of the less dense particulates from the surface of the liquid medium. Suitable separators will be described at length below.

From block 120, the method 100 follows two or more parallel paths, depending on the number of separation fractions or desired treatment of fat. While two parallel paths are illustrated, more than two fractions can be collected from the separator, and each fraction can be processed similarly, or may include fewer, additional, or different steps. For example, a first path represents the treatment of the first stream of mostly fat material, while a second stream represents the processing of a mostly lean meat material. For purposes of illustration, the process illustrated on the left side of FIG. 2 will represent the processing of lean meat material, while the process illustrated in the center and on the right side of FIG. 2 will represent alternatives for the processing of fat material. Block 122 includes processing by an apparatus which is herein described as a “chimney.” A chimney, as used in this application, is for separating solid materials from liquid and/or gaseous materials, for example, gaseous and liquid carbon dioxide. A chimney will be described in further detail below. The chimney of block 122 separates solid materials from liquid and gaseous carbon dioxide that may have been carried over with the material used in the separation block 120. Collection of carbon dioxide is advantageous from the standpoint of avoiding waste and the loss of carbon dioxide. From block 122, the method 100 enters block 124. Block 124 is for measuring the solid material exiting block 122. A suitable measuring instrument is similar to the measuring instrument described for block 118. From block 124, the method 100 enters block 126. Block 126 is for extracting work 128 by operating a pump as a generator. For example, since separator 120 and chimney 122 are operated at elevated pressures, the driving force for transferring material after separator and chimney blocks is via a drop in pressure, rather than from a mechanical rotating apparatus. The expansion of and/or the release of the pressure in the line through which material travels can operate a generator 128 that produces work. From block 126, the method 100 enters block 130. Block 130 is a final depressurizing step to bring the material to atmospheric pressure. Any residual carbon dioxide is collected as gaseous carbon dioxide and sent to the gaseous carbon dioxide collection system. From block 130, the method 100 enters block 132. Block 132 is for packaging the lean meat. Embodiments for packaging are described below. From block 132, the method 100 enters block 134. Block 134 signifies the end of one iteration of method 100. For material higher in fat, the process after separator block 120 can follow similar steps, or alternatively, a different process. Corresponding to blocks 122, 124, 126, 128, 130, and 132, are blocks 136, 138, 140, 142, and 146, respectively. In one alternate embodiment, material that is high in fat can be processed according to a second path. From separator block 120, fat particulate material can be reground in a fine grinder in block 150. The fine grinder can grind material using a grind plate with apertures of about 1/16″ to about ⅛″. From block 150, the method 100 enters block 152. Block 152 is for heating the twice ground fat material from block 150 to a temperature in the range of about 100° F. to 120° F. Preferably, the temperature can be maintained below 120° F. to avoid damage. From block 152, the method 100 enters block 154. Block 154 is for separating material via a centrifuge. Embodiments of the centrifuge are described below. The centrifuge can separate oil from solid materials. Solids include cartilage, collagen, connective tissue, cell walls, etc. The oil recovered from the centrifuge block 154 can be used, for example, to convert into biodiesel. Method 100 may be continuously applied to materials to continuously produce packaged products containing lean meat and/or fat.

Referring to FIG. 3, a portion of apparatus 200 is illustrated including the combo-dumper 104, the inclined conveyor 106, the hopper/grinder 108 and the transfer box.

The combo-dumper 104 can include a set of parallel tracks which elevate bins 1042 containing material to be ground into particulates for separation. Bins 1042 may be delivered to combo-dumper 104 via a forklift truck. Combo-dumper 104 elevates the bins 1042 with lifting tracks and empties the bins 1042 onto a horizontal conveyor 1044. The horizontal conveyor 1044 can include an endless conveyor belt disposed around two rotating rollers. The material from bin 1042 is conveyed horizontally on horizontal conveyor 1044, and is then transferred to the inclined conveyor 106. The purpose of the inclined conveyor 106 is to elevate the material from the horizontal conveyor 1044 to an elevation that reaches the unloading height at the hopper/grinder apparatus 108. The inclined conveyor 106 may include an endless conveyor belt disposed around a first and a second roller. Additionally, the conveyor belts for the horizontal and the inclined conveyors 106 and 108 can have transverse plates mounted to the belts, which compartmentalizes the conveyor belts into a type of “bucket” conveyor which can unload material in discrete quantities. The horizontal and inclined conveyors may be enclosed by ducting so that a gas, such as carbon dioxide, may be pumped therein to retard and/or prevent premature spoilage of the material by minimizing exposure to atmospheric oxygen. The inclined conveyor 106 deposits the material into the hopper/grinder apparatus 108.

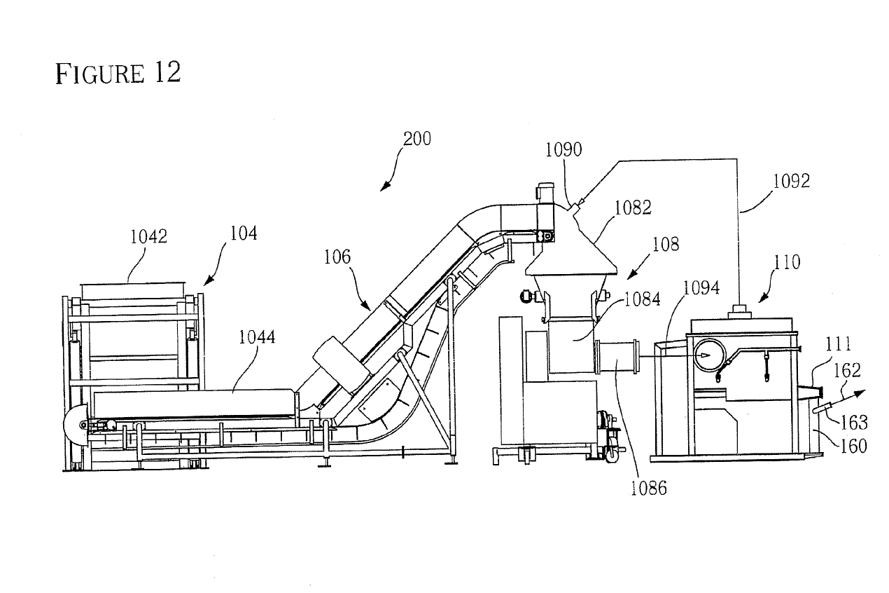

The hopper/grinder apparatus 108 includes a hopper portion 1084 and a grinder portion 1086. The hopper portion 1084 includes an area for holding deposited material before grinding. The hopper portion 1084 may be covered or enclosed by a hood 1082. The hood 1082 is connected to the ducting enclosing the horizontal and inclined conveyors 1044 and 106. Alternatively, the hood 1082 may vent to a gas collection system. Gaseous carbon dioxide vented from the transfer box 110 may be transferred into the hopper/grinder 108 via the vent line 1092 through the hood nozzle 1090. In this manner, material which enters the hopper/grinder 108 is exposed to an atmosphere substantially deficient of oxygen, which can be mostly comprised of carbon dioxide gas. A grinder 1086 is connected to the bottom section of the hopper 1084. The grinder 1086 grinds material into particulates that are fed into the transfer box 110. The grinder 1086 can utilize a cutting plate having holes in the size range from about ¼″ to about ½″. The advantage of grinding material to this size range is that the particulates that result tend to be either substantially all fat or substantially all lean meat. However, proportions of fat and lean meat in any individual particulate may vary from particulate to particulate. Material, such as beef in particle sizes less than ¼″ or greater than ½″ are generally disadvantageous because particles begin having about similar amounts of fat and lean meat, making separation by density more difficult. However, in one preferred embodiment it is required that material such as beef is ground twice. The first grind or pre-grind grinding plate was 0.5″ diameter holes and up to 3″ diameter holes, or wherein the largest piece/particle that can be ground with standard grinding equipment (i.e., Weiler 1109) is known as a “kidney plate” because of the profile of the apertures being similar to that of a kidney and wherein the apertures of the grinding plate may be described as roughly rectangular and approximately 5″ long×3.5″ wide, with two sides of the single cut piece (particle), having sides which are parallel radiuses and the other opposing pair of “sides” also having radiuses but which are bulging outward; and, in the next or second grinding, any sized holes such as ⅛″ to ¼″ diameter holes or even up to about ¾″ diameter can be used. In another preferred size for a second cutting (grinding) the plate holes are between ¼″ and up to ⅜″ diameter. The first grinder 1086 grinds particles from ambient atmospheric pressure (14.7 psi) into a gaseous carbon dioxide atmosphere of slightly positive pressure such that if the first in-line grinder is at 14.7 psi, the second, in-line grinder is located with the grinder in-feed “fed” directly by a positive displacement pump (PD pump) at a pressure of <500 psi or greater but not more than 600 psi and as necessary to grind the pumped beef particles with grind plate and knives therein provided. Multiple passes through the in-line grinders may be practiced, wherein the particle size is incrementally reduced with each pass through subsequent grinders. A conduit 1094 connects the outlet from grinder 1086 to the entrance nozzle of the transfer box 110. Transfer box 110 is described in further detail in association with FIG. 4. An alternate embodiment of the apparatus of FIG. 3 is illustrated in FIG. 12, which includes a pump apparatus 160.

Referring to FIG. 4, the transfer box (or pre-blender) 110 is a vessel which is substantially enclosed to provide an enclosed atmosphere of carbon dioxide which is substantially deficient of oxygen, i.e., partial pressure +<300 ppm and nitrogen having a partial pressure of +<800 ppm. The interior of the transfer box 110 is fitted with one or more shafts having an arrangement of paddles 1118 used for mixing. Paddles 1118 are disposed on the shaft 1116. The shaft 1116 is supported at both ends of the walls of the transfer box 110 via a set of bearings to permit rotation. One end of the shaft 1116 protrudes through the wall of the pre-blender vessel. A sprocket 1120 is connected on the shaft 1116 which protrudes to the exterior. A pulley 1128 is also connected to shaft 1116 at the end of shaft 1116. A second shaft (not shown) having a second set of paddles (not shown) is disposed directly behind the shaft 1116 and paddles 1118. The shaft that is not shown includes a sprocket (similar to 1120) which meshes with sprocket 1120, such that rotation of one shaft will drive the other to rotate in the opposite direction. The pulley 1128 is attached to drive belt 1130. A driver 1136 has a drive pulley 1132 which is connected to the end of the power transfer shaft from the driver 1136. The pulley 1132 is connected to the pulley 1128 via the drive belt 1130 to drive the shaft 1116. As can be appreciated, rotation of the shaft 1116 will cause an agitating motion to material deposited within the transfer box 110 via the action of the rotating paddles 1118. Paddles 1118 also transfer material deposited through entrance nozzle 1144 from the back to the front of the transfer box 110 to expose material to the greatest extent possible to liquid and/or gaseous carbon dioxide while resident within transfer box 110. Material eventually enters a recess 1146 disposed at the forward, bottom, and center of the transfer box 1110. A close tolerance screw conveyor 1122 is provided within the recess 1146. Material is transferred by the screw conveyor 1122 and a matching screw conveyor (not shown) through the exit nozzle 1140. Screw conveyor 1122 is connected to shaft 1124. The shaft 1124 is supported at both ends of the transfer box 110 via a set of bearings. One end of the shaft 1124 projects outside of the transfer box vessel 110. The end of the shaft 1124 which is on the exterior is fitted with a pulley 1126. Pulley 1126 is connected to driver 1138 via a drive belt. A second driver 1138 includes a drive pulley 1134. The drive pulley 1134 connects to the pulley 1126 to drive the shaft 1124 and the screw conveyor 1122. Although a single screw conveyor 1122 is illustrated, preferably, the transfer box 110 includes a first and a second screw conveyor, which can rotate opposite to screw conveyor 1122, but will transfer material forward. Only a single paddle 1118 and screw conveyor 1122 are shown for clarity and for brevity. The transfer box 110 is substantially enclosed, which allows the transfer box 110 to contain a modified atmosphere. The transfer box 110 includes liquid carbon dioxide injection nozzles. Liquid carbon dioxide is provided to injection nozzles from the liquid carbon dioxide supply line 1114 connected to a liquid carbon dioxide distribution system. The liquid carbon dioxide distribution system is described in further detail below. Liquid carbon dioxide injection nozzles are placed at a location to deliver liquid carbon dioxide below the material entrance nozzle 1144. By placing the liquid carbon dioxide injection nozzles at a low point on the transfer box 110 and below the entrance nozzle 1144, any oxygen transferred with material can be purged from the material entering via the entrance nozzle 1144.

The liquid carbon dioxide entering the transfer box 110 mixes intimately with the material entering via the entrance nozzle 1144 due to the placement of the liquid injection nozzles below the entrance point and the agitating action created by the paddles 1118. The transfer box 110 operating pressure is in the range from about 14.7 psig to about 14.9 psig and the operating temperature can be in the range from about 6° C. to about (negative) −2° C. Any liquid carbon dioxide which vaporizes is vented with any atmospheric gases collected there with, via the vent nozzle 1112 located at the upper portion of the transfer box 110. Gaseous carbon dioxide vented through vent nozzle 1112 can be collected and fed into the hood 1082 of the hopper/grinder 108 through the vent line 1092 (FIG. 3).

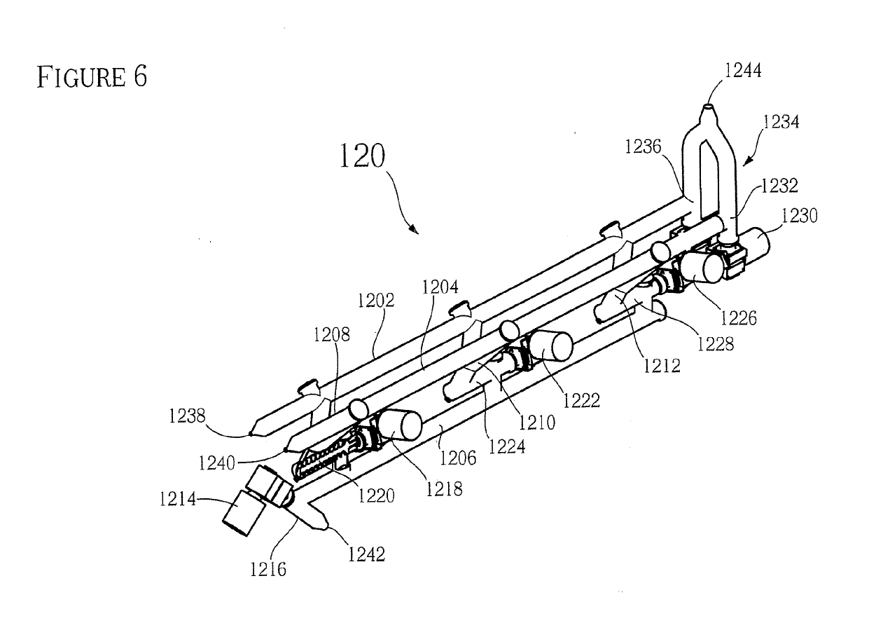

Returning to FIGS. 1 and 2, the material exiting the transfer box 110 via exit nozzle 1140 is pumped via the pump 112. Pump 112 delivers a head pressure of about 500 psi. From pump 112, the specific density, temperature, mass flow through the conduit where the material is measured via Coriolis measuring device 118. After passing through measuring device 118, material enters the separator 120. In one embodiment, the separator 120 is a settling vessel illustrated in FIG. 6. However, in another embodiment, a centrifuge can be the separator. Still other embodiments of separators are possible. A separator 120, as described herein, can separate particulates of fat and lean meat via the density differences between particulates. Particulates can be produced by grinding the boneless beef to an appropriate size range. Utilizing a grind plate with holes of about ¼″ to about ⅜″ is preferred because this size range results in particles that are substantially all fat or substantially all lean meat. Fat may include adipose tissue, but is generally referred to herein as fat for brevity. Pressure control at the separator 120 includes an increase of about 20 psi to 50 psi above the immediately previous pressure, and/or applying the pressure increase immediately prior to entry into or immediately after entry into the separator, cyclone, or inclined conduit to thereby effectively reduce the relative density of the liquid carbon dioxide and carbonic acid (CO₂/H₂CO₃) fluid medium versus the density of the lean and fat particles.

Referring to FIG. 6, a separator 120, which is used to separate materials utilizing a settling process, is illustrated. The separator 120 includes a first elongated hollow tube 1202, a second elongated hollow tube 1204, and a third elongated hollow tube 1206. Other embodiments may comprise fewer or additional tubes. The tubes 1202, 1204, and 1206 are generally attached parallel to each other. The operating pressure of tubes 1202, 1204, and 1206 is in the range of from 500 psig to 750 psig. The conduit from measuring device 118 (FIG. 2) is separated into two distinct conduits via a Y connector so as to feed two of the tubes. Alternatively, a single tube can be used. The tube 1202 and the tube 1204 each include an inlet nozzle 1238 and 1240, respectively. The legs of the Y connector respectively connect to one of the nozzles 1238 and 1240. Prior to, or via a separate nozzle (not shown), liquid carbon dioxide can be injected into the tubes 1202 and 1204. The tubes 1202 and 1204 are connected to one another at several locations along the length of the tubes. The locations where tubes 1202 and 1204 connect to one another are approximately at both upper and lower ends and about midpoint in the tubes. Each location where the tubes 1202 and 1204 are joined is provided with a Y connector 1208, 1210, and 1212. Each Y connector has a first and a second leg, each extending from a common third leg. Each of the upper legs of the Y connectors 1208, 1210, and 1212, respectively, connect to the lower side of tube 1202 and tube 1204. The common leg of the Y connectors 1208, 1210, and 1212 connects to a housing 1220, 1224, and 1228, each of which houses a screw conveyor. In operation, the assembly of tubes 1202, 1204, and 1206 is inclined at an angle from the ground plane, which can be greater than 0, up to and including a right angle of 90° from the ground plane. Inclining the separator 120 is advantageous to utilize the force of gravity to assist in settling of materials toward the bottom of the assembly. Legs of the Y connectors 1208, 1210, and 1212, which connect to either of tubes 1202 or 1204 are provided to transfer settled material from tubes 1202 and 1204 into the housing sections 1220, 1224, and 1228. The screw conveyors within each of the sections 1220, 1224, and 1228 is driven respectively by the drivers 1218, 1222, and 1226. It is noteworthy to point out that Y connectors 1208, 1210, and 1212 are inclined with respect to the tubes 1202 and 1204 so as to be nearly perpendicular to the ground plane. Furthermore, connections of the Y connectors 1208, 1210, and 1212 to each of the tubes 1202 and 1204 are made at the lower surface thereof so as to capture settled material which accumulates in the lower portions of tubes 1202 and 1204. Therefore, material that settles at the bottom and along the length of the tubes 1202 and 1204 will be transferred via the Y connectors 1208, 1210, and 1212 into the screw conveyor housings 1220, 1224, and 1228. From there, the settled material will be transferred to a third tube 1206, where material further settles along the bottom of tube 1206, which ultimately settles to the lower end of tube 1206 at the housing 1216 also housing a screw conveyor.

The series of tubes 1202, 1204, and 1206 can be enclosed and sealed such that the tubes can be pressurized up to 1500 psia. The entire internal space of tubes 1202, 1204, and 1206 and connections can be filled with a fluid, such as liquid carbon dioxide. Particulates that are introduced into tubes 1202 and 1204 will then either tend to float or sink depending on the density. Fat will tend to float upward and in the direction along the length of tubes 1202 and 1204. Lean meat will tend to sink and flow in the opposite direction and fall through the legs of one of the Y connectors 1208, 1210, and 1212. Any fat falling through Y connectors can be agitated and will be able to float upward through Y connectors 1208, 1210, and 1212 back into tubes 1202 and 1204. Any lean meat that may have been carried with fat has the opportunity to sink downward into tube 1206 through Y connectors 1208, 1210, and 1212. It can be seen, therefore, that substantially all lean meat will ultimately settle toward the lower end of tube 1206 to be transferred out of separator 120 through outlet nozzle 1242, while fat will most likely float upward through tubes 1202 and 1204 into housings 1232 and 1236 to be carried out of separator 120 through outlet 1244.

In another embodiment, water can be substituted for carbon dioxide such that only water alone is used as the fluid medium used in any apparatus to enable separation of fat and lean meat. In this embodiment, excess water that may be retained with the separated lean meat can be removed by exposure to anhydrous carbon dioxide. Furthermore, such water may also contain (acidified) sodium chlorite solution in small quantities used as a “dip” which is then followed by immersion of the separated lean meat in liquid carbon dioxide to remove excess water.

The ends of tubes 1202 and 1204 distal to entrance nozzles 1238 and 1240 are connected to perpendicular conduits 1236 and 1232, each housing a screw conveyor therein. A driver 1234 (not shown) drives the screw conveyor in housing 1236, and a driver 1230 drives the screw conveyor in housing 1232. Housings 1236 and 1232 join to form a single outlet nozzle 1244. Screw conveyors cannot be effectively used as substitute “valves” when liquid carbon dioxide at any pressure that carbon dioxide can be retained as a liquid, is combined with any other solid particulate, which is beef in this instance.

Liquid carbon dioxide, particulate materials including particulates of fat, particulates of lean meat, and particulates having both fat and lean meat are injected into the tubes 1202 and 1204 via the entrance nozzles 1238 and 1240. Liquid carbon dioxide, fat particulates, lean meat particulates, and particulates having both fat and lean meat begin flowing within the tubes 1202 and 1204, generally in an upward direction with the flow of the liquid carbon dioxide toward housings 1236 and 1232. The pressure and temperature of the liquid carbon dioxide is controlled to result in a density which will allow the particulates that are denser than the liquid carbon dioxide to settle toward the bottom of the tubes 1202 and 1204 and along the length of the tubes, while particulates that are less dense than the liquid carbon dioxide will not settle and will remain with the liquid carbon dioxide or float to the top and are carried with the liquid carbon dioxide along the entire length of tubes 1202 and 1204. The density of liquid carbon dioxide can range from 50 lbs/cu. ft. to 65 lbs/cu. ft.; 53 lbs/cu. ft. to 62 lbs/cu. ft.; 55 lbs/cu. ft. to 60 lbs/cu. ft.; and 57 lbs/cu. ft. to 59 lbs/cu. ft. Generally, the density of liquid carbon dioxide is about 58 lbs/cu. ft. The physical size of any beef particulates, as referenced herein can be adjusted in a grinder, according to needs but will generally be all of a similar size; this will be determined by the grinding plate hole size; for example, if a 0.25″ diameter hole size grind plate is installed, the particulate size will be approximately 0.25″ diameter by any selected length such as 0.25″ long. Any suitable particulate or particle size can be provided according to needs such as 0.125″ diameter by 0.125″ long, alternatively, 0.375″ diameter by 0.375″ long. Most preferably, however, the particulate size will have a length shorter than the diameter of said particulate, such as in the order of 0.25″ diameter by 0.15″ long. The diameter of each particle processed by the second “in-line” grinder as disclosed herein, for the purposes of separation in any of the separation vessels and methods herein disclosed, therefore, may be of any size between about 0.125″ to 0.75″ diameter by 0.075″ to 1″ in length.

The amount of liquid carbon dioxide in the separator 120 is about four times the solid material by weight or volume. Water may optionally be introduced with liquid carbon dioxide. Water may optionally contain salt, such as sodium chlorite, which is blended to provide 500 parts per million (ppm) to 1.2 million ppm or more in solution. Any other salts or additive may be included; however, sodium chlorite is a preferred salt since an anti-microbial effect can be achieved with such a blend. Liquid carbon dioxide, when included in the slurry, maintained at a pressure of approximately 500 psi to 750 psi, and at a temperature of 29.5° F. up to 36° F., when combined with sufficient water can create a pH value of 2.9, which is adequate to react with sodium chlorite, the combined quantity creating acidified sodium chlorite which has anti-microbial properties capable of reducing bacteria by several logs. Furthermore, the addition of sodium chlorite can be added in such proportions so as to adjust the specific density of the liquid which can be utilized to enhance the separation of fat particulates from lean meat particulates. For example, liquid carbon dioxide at about 725 psi, and 32° F. may have a specific gravity of 0.94, and the addition of, for example, 3% water containing sodium chlorite of 1200 ppm can increase the specific gravity of the liquid carbon dioxide to about 0.95. At such specific gravity, fat will float quite readily. However, at a specific gravity of 0.93, fat may tend to sink and prove difficult to separate from the lean meat. Particulates settle along the bottom of tubes 1202 and 1204 and pass into the Y connectors 1208, 1210, and 1212, depending on the settling rate. Although three Y connectors connecting tubes 1202 and 1204 to the third tube 1206 are illustrated, it is to be understood that fewer or additional Y connectors can be provided. Generally, the heavier, denser particulates, i.e., the particulates comprising the greatest proportions of lean meat, will settle first and pass through Y connector 1208, the next less dense through Y connector 1210, and the least dense through Y connector 1212. While all Y connectors feed into the same third tube 1206 where the lean meat may combine, in other embodiments, material gathered at each Y connector can be segregated from other settled material to provide a way of producing three streams of product each having a different proportion of lean meat owing to the elevation at which the particulates are collected. The lean meat particulates that are collected through any Y connector are transferred by the screw conveyor connected to the third, common legs of the Y connectors 1208, 1210, and 1212. Screw conveyors in housings 1220, 1224, and 1228 function to convey lean meat particulates collected through Y connectors from tubes 1202 and 1204 into the third tube 1206. Tube 1206 is parallel to tubes 1202 and 1204, but is at a lower elevation that tubes 1202 and 1204. Additionally, screw conveyors 1220, 1224, and 1228 may remove some of the liquid carbon dioxide from the collected lean meat particulates, which is then transferred back into the Y connectors 1208, 1210, and 1212 and into tubes 1202 and 1204. Lean meat particulates deposited into the tube 1206 from the Y connectors 1208, 1210, and 1212 will settle by gravity toward the lower section of tube 1206 into housing 1216 that contains a screw conveyor. Screw conveyor in housing 1216 transfers settled material and liquid carbon dioxide from tube 1206 out through the outlet nozzle 1242 and is forwarded to a chimney in the process block 122 of FIG. 2. The fat particulates (those which do not have time to settle) and liquid carbon dioxide flow upwardly through tubes 1202 and 1204, as mentioned above, and are transferred by screw conveyors contained in housings 1236 and 1232 at the top end of tubes 1202 and 1204 via the outlet nozzle 1244. From outlet nozzle 1244, fat particulates and liquid carbon dioxide are transferred to a second chimney, shown as process block 136 in FIG. 2.

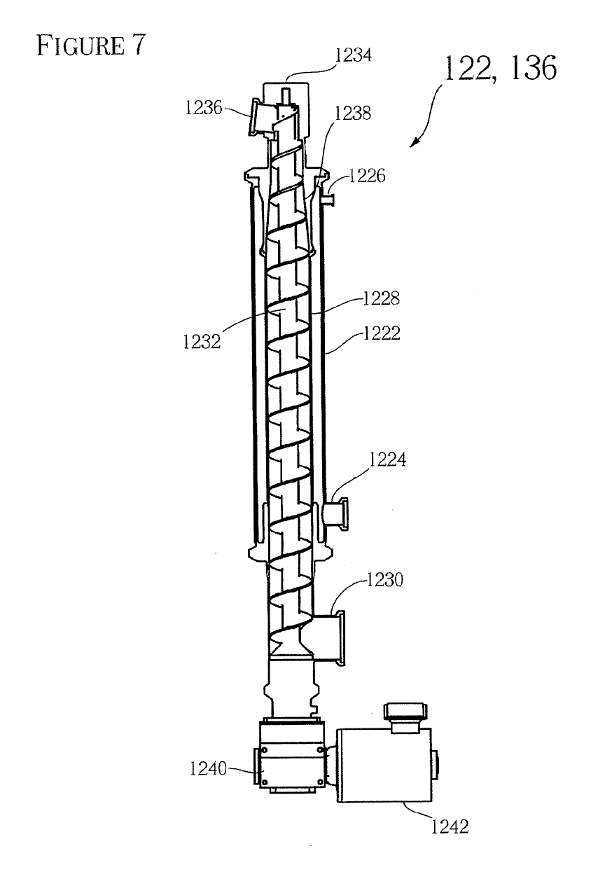

Referring to FIG. 7, a representative chimney is illustrated for use as chimneys 122 and 136. Both chimneys 122 and 136 are substantially similar to one another. However, the fat material may contain greater amounts of liquid carbon dioxide. Nevertheless, lean meat particulates also contain amounts of liquid carbon dioxide. Both chimneys 122 and 136 are substantially similar in construction and operation. Chimneys 122 and 136 include an outer vessel 1222 and an inner vessel 1228. The outer vessel 1222 surrounds a portion of the inner vessel 1228 so that the outer vessel 1222 does not surround the inner vessel 1228 at a lower section. The inner vessel 1228 and the outer vessel 1222 define a space therebetween. The wall of the inner vessel 1228 is perforated where it is surrounded by the outer vessel 1222 so that the liquid level in the chimney is at the same height for both the outer vessel 1222 and the inner vessel 1228. The outer vessel 1222 includes an inlet nozzle 1226 at the upper section and an outlet nozzle 1224 at a lower section thereof. Carbon dioxide gas, heated to about 60° F., is provided at the inlet nozzle 1226. Liquid carbon dioxide is maintained within the chimney at a predetermined level. The liquid carbon dioxide is removed via the outlet nozzle 1224 to maintain a level in the outer vessel 1222 and the inner vessel 1228. The inner vessel 1228 includes an inlet nozzle 1230 at a lower section thereof and an outlet nozzle 1236 at an upper section thereof for material, i.e., the fat or lean streams. A helical screw conveyor 1232 is provided in a close fitting relationship within the interior of the inner vessel 1228. The helical screw conveyor 1232 is driven by driver 1242 and gearbox 1240. Helical screw 1232 is operated to transfer material introduced through inlet nozzle 1230 in an upwardly direction. The inner vessel 1228 has perforated walls to allow liquid carbon dioxide to be drained therefrom. The inner vessel 1228 begins to taper from a larger diameter to a smaller diameter at the upper section thereof. Likewise, the helical screw conveyor 1232 also tapers from a large diameter to a smaller diameter at the upper section thereof. By reducing the taper of the helical screw 1232 and the inner vessel 1228, the material carried therein will be compressed thereby squeezing liquid carbon dioxide from the material to allow draining into the outer vessel 1222. Furthermore, the compression of the material at the tapering portion 1238 compresses the material sufficiently to act as a pressure-tight plug to maintain pressure within the chimney and the outer vessel 1222. The tapered section of the inner vessel 1228 may be devoid of perforations. As the vessel 1228 has perforations in the walls thereof surrounded by the outer vessel 1222, the pressure is equalized between the inner vessel 1228 and the outer vessel 1222. The operating pressure of chimneys 1222 and 1228 is about 350 psig to about 500 psig. Both lean meat particulates and fat particulates from the separator 120 are processed in a similar fashion in one of the chimneys 122 and 136. Injecting gaseous carbon dioxide injected into inlet nozzle 1226 is provided by the carbon dioxide distribution system, while liquid carbon dioxide removed from nozzle 1224 is sent to or supplied by the liquid carbon dioxide distribution system. Gaseous carbon dioxide causes vaporization of some of the liquid carbon dioxide, which results in cooling. Lean meat particulates or fat particulates are transferred out of the respective chimney 122 or 136 from the outlet nozzle 1236 to measuring devices, which is process block 124 for lean meat particulates and process block 128 for fat particulates (FIG. 2). After measuring, lean meat materials are transferred to pump 126, while fat particulates are transferred to pump 140, as illustrated in FIG. 2.

The liquid carbon dioxide level maintained in the chimneys 122 and 136 is kept higher than the common outlet from the tubes 1202 and 1204. However, this is a consequence of an open, equalized carbon dioxide distribution system. In other carbon dioxide distribution systems, the liquid level in chimneys 122 and 136 may not need to be maintained higher than the exit of the tubes 1202 and 1204.

Pumps 126 and 140 are designed to operate in a reverse fashion. Because the pressure in the chimneys 122 and 136 is on the order of about 400 psi to 800 psig, which eventually needs to be reduced to atmospheric pressure for packaging, the pressure drop can be used to drive a generator connected to the rotor of the pump. The generator 128 is connected to pump 126, while the generator 142 is connected to pump 140. As the pressure drops in the conduit through which material traveling from the inlet of the pump 126 or 140 to the outlet of the pump 126 or 140, the drop in pressure results in the vaporization of carbon dioxide and an attendant increase in volume. Such expansion can be utilized to drive gas turbine generators. Therefore, generators 128 and 142 can produce electricity which can be connected to a local power distribution system or fed into any utility line. The outlet of the pumps 126 and 140 is on the order of 100 psig. However, the pressure needs to be reduced to atmospheric. To this end, depressurization vessels 130 and 144 are provided downstream from pumps 126 and 140, respectively. Depressurization vessels 130 and 144 extract additional carbon dioxide in the form of gas which is introduced into the carbon dioxide distribution system.

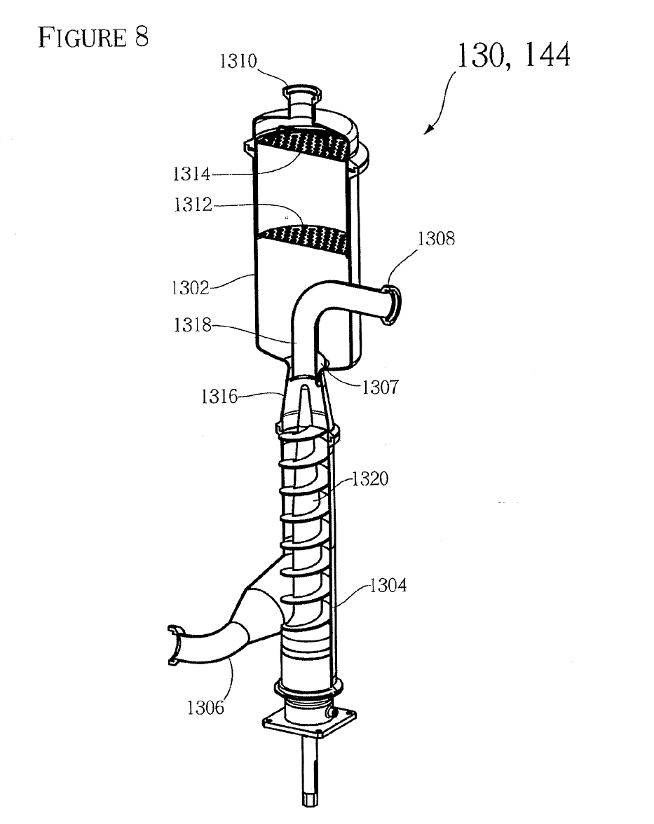

Referring to FIG. 8, depressurization vessels 130 and 144 are illustrated. Depressurization vessel 130 is for use with the lean meat particulate material, while depressurization vessel 144 is used with the fat particulate material. The construction and operation of depressurization vessels 130 and 144 is substantially similar to one another. The depressurization vessels 130 and 144 include an upper housing 1302 and a lower housing 1304. The lower housing 1304 includes a helical screw conveyor 1320. The helical screw conveyor 1320 is driven by a driver (not shown). Lower housing 1304 includes the inlet nozzle 1306 through which lean meat particulate material or fat particulate material is fed to housing 1304. Material introduced into housing 1304 is then conveyed via the screw conveyor 1320 through tapered conduit 1316 which enters upper housing 1302 and makes a 90° bend and exits at the outlet nozzle 1308. After leaving housing 1304, material being transferred therethrough is at atmospheric pressure. Gaseous carbon dioxide released during the drop in pressure flows into the upper housing 1302 around the bottom of conduit 1318 via an annulus. The upper housing 1302 includes one or more perforated grates, such as perforated grates 1312 and 1314. Grates 1312 and 1314 are placed at differing heights in the housing 1302 and substantially cover the entire cross-sectional area of the interior of housing 1302. Grates 1312 and 1314 prevent solid materials from being carried over or entrained with the gaseous carbon dioxide. Gaseous carbon dioxide leaves housing 1302 via upper outlet nozzle 1310 and is returned to the carbon dioxide distribution system. From depressurization vessels 130 and 144, particulate material is at atmospheric pressure and can now be packaged in respective suitable packages for lean meat particulates in process block 132 of FIG. 2 or in process block 146.

In another embodiment, a pair of (two) separators, similar to the apparatus shown in FIG. 6, can be arranged such that meat processed in a first separator can be transferred under pressure directly into a transfer box, similar to the one of FIG. 4, via a sealed, gas tight first conduit, and a second stream of processed meat can be transferred under pressure from a second separator into the transfer box. In this way, two streams of processed meat can be further measured, combined, and/or treated.

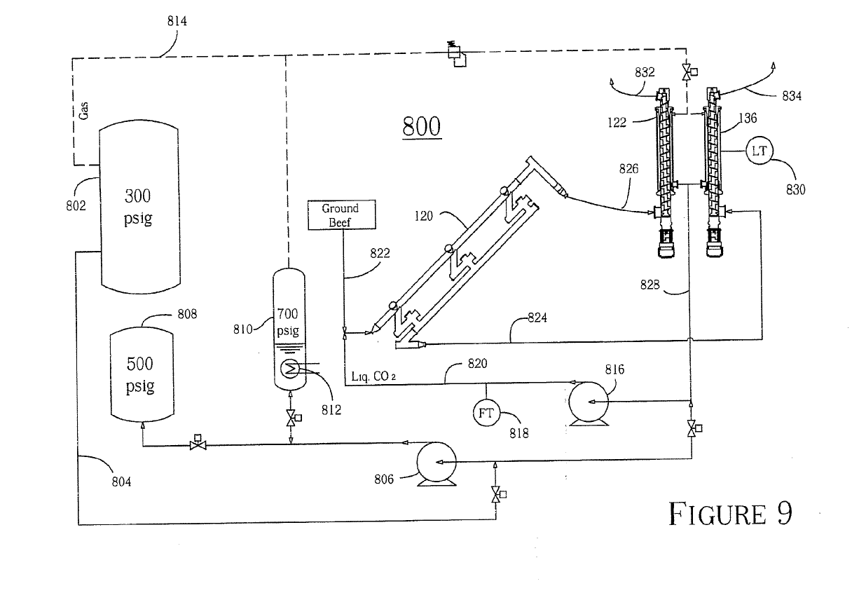

Referring to FIG. 9, a representative carbon dioxide distribution system for use with the above-described system is schematically illustrated. Carbon dioxide storage tank 802 is provided at a convenient location for intermittent refilling of the tank 802. The tank 802 is maintained at a pressure of about 300 psig. In this condition, the carbon dioxide can remain as a liquid at a temperature of 60° F. Liquid carbon dioxide line 804 leads from tank 802 to a pressure booster pump 806 which boosts the pressure of liquid carbon dioxide to a pressure of about 500 psig to 700 psig for delivery to tanks 808 and 810. Tank 808 contains liquid carbon dioxide at about 500 psig. Tank 810 contains liquid carbon dioxide at a pressure of about 700 psig. Tank 810 includes a heater 812 to maintain the pressure at 700 psig by increasing the temperature. Each vessel 808 and 810 can have a pressure relief valve which vents into a gaseous carbon dioxide header 814 which returns to storage tank 802. The 300 psig pressure line 804 connects to the liquid outlet nozzle 1224 on chimneys 122 and 136. Liquid carbon dioxide from chimneys 122 and 136 that is drawn from the outlet nozzle 1224 passes via line 828 to the 300 psig liquid carbon dioxide line 804. A level transmitter 830 controls the amount of liquid carbon dioxide that is withdrawn from chimneys 122 and 136 to maintain a constant level. A takeoff line from the 300 psig liquid carbon dioxide line leads to booster pump 816. Booster pump 816 increases the pressure from about 300 psig to about 500 psig for pumping into the separator 120. A flow meter 818 is provided in line 820 to measure the amount of liquid carbon dioxide flow into the separator 120. This higher pressure liquid carbon dioxide is combined with the ground particulate material line 822 including both fat particulate material and lean meat particulate material. As discussed above, liquid carbon dioxide exits both with the separated lean meat particulate material in bottom line 824 and with the fat particulate material via overhead line 826. Bottom line 824 connects to outlet nozzle 1242 of tube 1206 (FIG. 6). Overhead line 826 connects to common outlet nozzle 1244 of tubes 1202 and 1204 (FIG. 6). Gaseous carbon dioxide added to chimneys 122 and 136 is fed from the gaseous carbon dioxide header 814 which is connected to the storage tank 802.

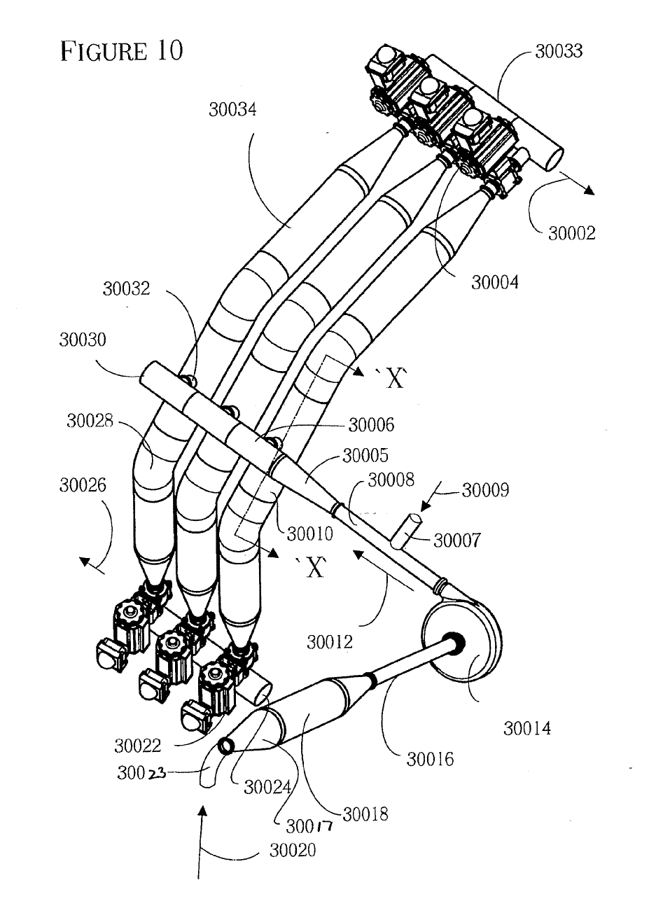

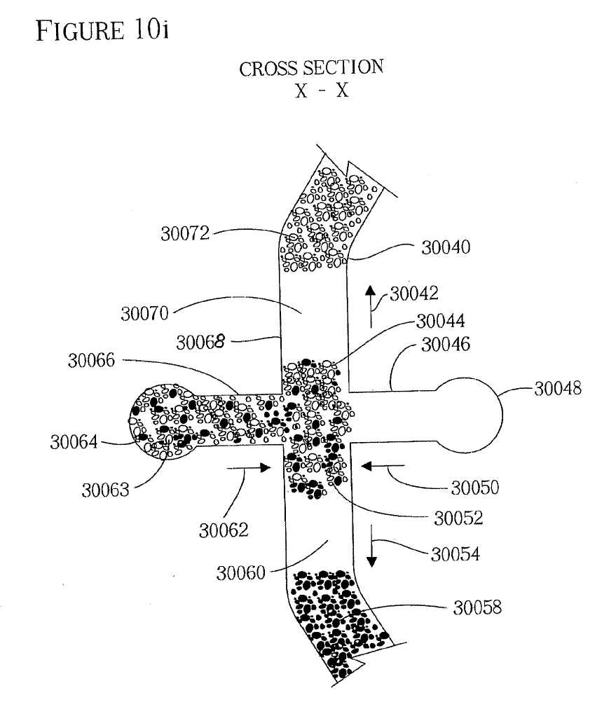

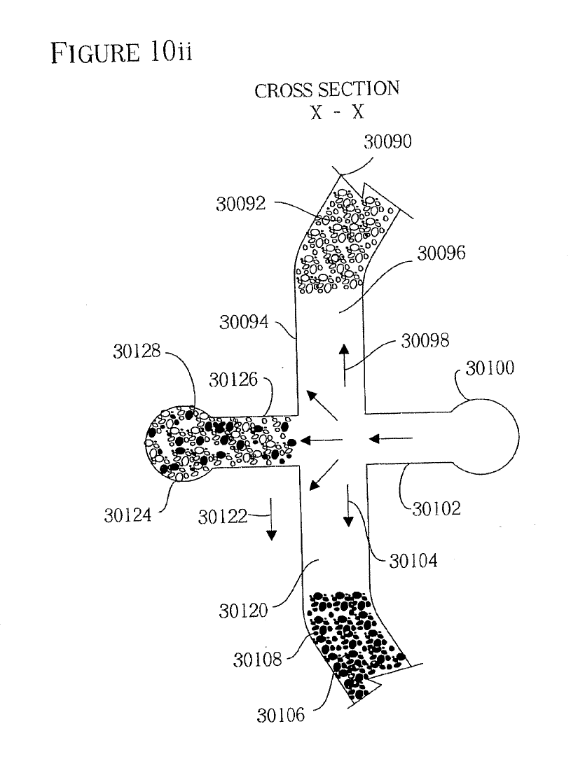

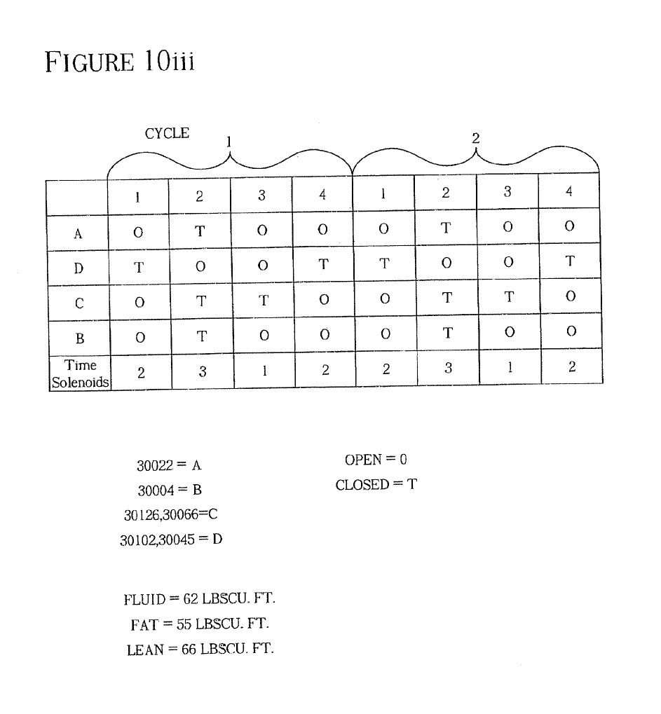

Referring now to FIGS. 10, 10i, and 10ii, an embodiment of a separator is disclosed that may replace separator 120 of FIG. 6. FIG. 10 illustrates a sub-assembly of three separation tubes such as 30034 arranged in their operating position and shown three-dimensionally with a feeding tube 30030 connected at the mid point of each separation tube by a connection conduit such as 30032 and 30006. The sub-assembly is arranged with each of the three separation tubes terminating at the upper end with a ball valve such as 30004 which connects to extraction conduit 30033 and at the lower end of each tube the termination is defined by a lower ball valve such as 30022 connected to separation tube 30010 with extraction tube 30024. The entire sub-assembly is integrated into a complete system arranged to separate lean ground beef from fat component. A centrifugal pump 30014 is fed by conduit 30016 which pumps fluid along conduit 30008 in the direction shown by arrow 30012. Centrifugal pump 30014 also elevates pressure of the fluid transferred to conduit 30008. Vessel 30018 is connected to conduit 30016 and in a preferred embodiment crushed ice (frozen water) fills the space contained by vessel 30018 being retained within said space by perforated metal and any other suitable arrangement which will allow liquid carbon dioxide or any other suitable liquid transferred under pressure in the direction shown by arrow 30020. A conduit 30007 provides a stream of ground beef in the direction shown by arrow 30009 such that fluid transferred in the direction shown by arrow 30012 blends with said ground beef which is then transferred directly into conical direction tube 30005 and to manifold conduit 30030.

FIGS. 10i and 10ii illustrate how the separation of the lean from fat particles of ground beef occurs in a chamber. A representative cross-sectional view is provided across tube 30010 (FIG. 10). Fresh liquid carbon dioxide is provided under pressure into conduit 30018 in the direction shown by arrow 30020 and at a rate suitable for the process which can be one to seven or more times the volume of ground beef transferred via conduit 30007 such that the anhydrous liquid carbon dioxide transferred through conduit 30023 followed by cone 30017 and then vessel 30018 within which crushed ice is packed. The anhydrous fluid, therefore, has intimate contact with the frozen water in the vessel 30018 and thereby becomes hydrated and the solid frozen water reacts with the carbon dioxide in liquid form and carbonic acid is thereby produced in liquid form and is transferred through conduit 30016 to centrifugal pump 30014 from which the fluid blend of carbonic acid and liquid carbon dioxide is pumped in substantial volumes via conduit 30008 blending with frozen ground beef particles transferred via conduit 30007 in the direction shown by arrow 30012.

As a result of carbon dioxide passing over ice, water saturates, or at least dissolves in the liquid carbon dioxide. Water molecules are carried with the liquid carbon dioxide. When the liquid carbon dioxide contacts the ground beef, the water molecules are released from the carbon dioxide. The released water can then be picked up by the ground beef to rehydrate the ground beef. In accordance with one aspect of the invention, the amount of rehydration can be controlled, for example, by adjusting the pressure of the carbon dioxide. If the pressure is lowered, for example, the saturation point drops and water will be released from the liquid carbon dioxide due to the drop in the pressure. The pressure of the liquid carbon dioxide as it passes over the ice can be in the range of about 350 psi or greater. Then, the pressure of the carbon dioxide can be reduced in the range of 320-300 psi immediately before or at the time of contact with the ground beef so as to cause the release of water to rehydrate the ground meat. This water is then available to be absorbed by or dissolved into the ground beef. An advantage of this process is that the liquid carbon dioxide also acts as an antimicrobial, and the water carried by the liquid carbon dioxide is beneficial to rehydrate ground beef that has lost water through the normal course of other processes, such as grinding, and/or in the course of transporting the ground beef through conduits. A further advantage results from the formation of carbonic acid when liquid carbon dioxide comes in contact with water in any form. In accordance with one aspect of the invention, the carbonic acid can be used to assist in the retention and/or the enhancement of the color of the ground beef, which is prolonged due to contact with carbonic acid. Such color enhancement of the ground beef due to carbonic acid is believed to extend the color for about two to three weeks.

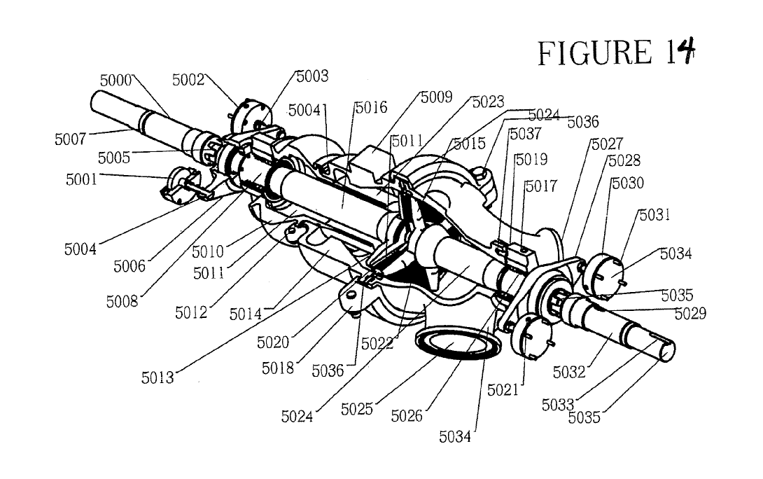

Ground beef particles which most preferably will have been ground by an in-line grinder such as is shown in association with FIGS. 14, 15, and 16 and, therefore, comprises particles of lean beef or beef fat but wherein the particles are substantially equal in size and have been frozen individually such that all particles are separately carried in suspension with the large volume of liquid carbonic acid and/or liquid carbon dioxide. The system pressure provides for the fluid transferred through conduit 30016 to be at approximately 300 psi and 0° F., however, when transferred through and by centrifugal pump 30014 to conduit 30008 the pressure is increased by the centrifugal pump 30014 to about 350 psi. Pressure of frozen ground beef particles transferred via conduit 30009 is slightly higher than the pressure of fluid transferred via conduit 30008. For example, if the pressure of fluid transferred by centrifugal pump 30014 is 330 psi, the pressure of the fluid transferred via conduit 30007 can be approximately 340 psi. The rate of mass flow of liquid carbonic acid and/or liquid carbon dioxide transferred via pump 30014 is approximately 7 times the volume of ground beef mixed therewith after transfer through conduit 30007. A suspension comprising fluid carbonic acid and/or liquid carbon dioxide and frozen particles of ground beef are, therefore, transferred via conical connecting tube 30005 and into manifold 30030 generally in the direction shown by arrow 30012. In this way, a continuous supply of fluid comprising suspended ground beef particles in carbonic acid is provided to manifold 30030 and at a rate equal to the amount extracted via connecting conduits such as 30032 or 30006 and into the mid section of separation tubes such as 30034 and 30010. The supply of suspended frozen ground beef particles in carbonic acid and/or liquid CO₂ is provided according to demand and the total system is controlled by a central PLC such as can be provided by Allen Bradley by way of pressure transducers located throughout the system most particularly located upstream and downstream of pumps and valves.

Referring now to FIG. 10i, a cross section of tube 30010 is shown. A manifold 30048 carrying liquid carbon dioxide at a pressure of 350 psi to 370 psi is shown connected to the mid section 30068 of the tube 30010 via conduit 30046 opposite to the connecting conduit 30066 which represents connecting tube 30006 of FIG. 10. Ground beef particles are represented by solid dots representing lean and small circles of similar size representing fat are randomly located in zones of the FIG. 10i. FIG. 10 does not show conduit 30048 with connection tube 30046 of FIG. 10i; however, conduit 30048 is arranged to provide pressurized liquid carbon dioxide or liquid carbonic acid at a controlled pressure wherein a ball valve or similar valve such as gate valve or plug valve can be provided on connecting conduit 30046 between conduit 30048 and mid section 30068 of tube 30010 to open and close the flow of fluid via conduit 30046 in the direction shown by arrow 30050. Similarly a valve is provided on connecting conduit 30066 between conduit 30064 and the midsection 30068 of tube 30010 to control the flow of frozen ground beef particles suspended in a fluid and transferred in the direction shown by arrow 30062 through connecting conduit 30066. In this way, the contents of each separation tube such as 30010 of FIG. 10 can be isolated by closing a valve provided in conduit 30046 and closing a valve provided in conduit 30066 when the upper and lower valves 30004 and 30022 of the separation tube 30010. More particularly, when valves 30004 and 30022 are both closed, the closing of the valves (not shown) in conduits 30066 and 30046 substantially isolate the contents in space 30070 and 30060 of separation tube 30068 shown in FIG. 10i and tube 30010 shown in FIG. 10. The opening and closing of any valve in the system, including the apparatus shown in FIG. 10, and all other apparatus required to operate the system as described herein is controlled by a centralized PLC programmed to open and close all valves according to a predetermined sequence that maximizes the benefits of utilizing fluidic carbonic acid and/or liquid carbon dioxide when particles of frozen ground beef are suspended in the fluid. Fresh clean filtered anhydrous liquid carbon dioxide (otherwise known as carbonic anhydride) which may have been recycled having been used in earlier separation sequences is transferred through vessel 30018 thereby contacting intimately with the extensive surface area of crushed ice packed within the vessel 30018. This process, therefore, hydrates the anhydrous liquid carbon dioxide pumped therein via conduit 30023. The pressure of the anhydrous liquid carbon dioxide may be in the order of 280 psi as it is transferred through conduit 30023 into the crushed ice contained in the vessel 30018 and then into conduit 30016 which connects directly with centrifugal pump 30014. The hydrating of liquid carbon dioxide which produces carbonic acid may have a pH of about 4 units or it may be as low as 3 units but in any circumstances will be of such acidic value so as to be lethal to pathogens such as eColi 0157H7. This property is helpful in the reduction of any pathogens that may be present with the ground beef treated as it is processed within the apparatus described herein primarily for the purpose of separating lean particles from beef fat particles. The lowest pH value that can be created by using the apparatus herein described wherein the controlled pressure enables the production of carbonic acid having a pH value of as low as 3.5 units and even below 3 units. The process described in association with FIGS. 10, 10i, and 10ii, uses a volume of fluid approximately seven times the volume of ground beef particles suspended within the fluid. Such conditions are conducive to maintaining lower pH values since the buffering effect of the beef is minimized firstly when frozen and substantially encapsulated within a frozen shell of water and when the volume of liquid carbonic acid is overwhelming as the ratio of 7 parts carbonic acid to 1 part frozen ground beef particles could reasonably be described. These conditions, therefore, are likely to substantially pasteurize or in other words reduce the living population of pathogens by 4 or more logs. It has, however, been demonstrated that the population of pathogens can be reduced to undetectable levels when processed in the manner most preferable for effective separation of fat particles from lean particles as described herein, however, when such large volumes of fluid compared to the volume of frozen ground beef particles are required, the total quantity of ground beef processed is reduced when compared with, for example, 3 parts liquid carbon dioxide and one part ground beef. Nevertheless when operated in the manner wherein 7 parts liquid carbon dioxide are blended with 1 part frozen ground beef particles, the effectiveness of the separation is such that a very high percentage lean beef can be produced while simultaneously reducing pathogen population to undetectable levels or more specifically pasteurized high lean content ground beef can be produced from low cost ground 50's wherein 50's is the term representative of commodity boneless beef having 50% lean content and the balance of 50% beef fat.

Referring again to FIGS. 10i and 10ii two stages of the separation process are illustrated for a chamber. One embodiment comprises the sequencing of opening and closing valves. The sequence can be programmed to be repeated in each separation conduit such as separation conduit 30010 with upper valve 30004 located at the termination of the upper end of the separation conduit 30010 and with valve 30022 located at the termination of the lower end of separation conduit 30010. The cross section “X-X” of separation tube 30010 is shown in FIGS. 10i and 10ii. It should also be understood that a suitable rapid operating ball valve or equivalent may be located in conduits 30066 and 30046 of FIG. 10i and conduits 30126 and 30102 of FIG. 10ii. The separation tube 30010 is illustrated in FIGS. 10i and 10ii with cross section “X-X” representing the two phases of a separation cycle in which four valves represented by 30022 and 30004 which represent the lower and upper valves located at the termination of the lower and upper separation conduit 30010. A table shown in FIG. 10iii shows the opening and closing sequence of the four valves wherein valve 30022 is represented by the letter “A”, valve 30004 is represented by the letter “B”, valve not shown located in conduit 30066 is represented by the letter “C” and the valve located in conduit 30046 is represented by the letter “D”. The valve of conduit 30126 in FIG. 10ii is the same as valve “C” and the valve provided in conduit 30102 is represented also by the letter “D”. The tabulated sequences of a single cycle are shown in FIG. 10iii wherein open is represented by the letter O and closed is represented by the letter T. The first column “1” of the table shown in FIG. 10iii shows valves A, C, and B open, with valve D closed. In this configuration, the end of any given cycle terminates with the loading of a fresh quantity of suspended frozen beef particles injected via an open valve in conduit 30066 allowing the removal of fat particles via valve B (shown as 30004 in FIG. 10) into manifold conduit 30033 joining a combination of fat particles transferred therein from all other separation tubes. Valve A (shown as 30022 in FIG. 10), also open, allows lean meat particles to be transferred into conduit 30024. Any number of separation tubes may be arranged either in a continuous section (in series) side by side or in groupings of separation tubes adjacent and in “parallel,” however, it is preferable to incorporate the separation tubes which effectively operate in batches of semi-continuous operation. However, given multiple separation tubes are connected to the inlet manifolds of common origin and outlet manifolds comprising a single upper and lower tube wherein fat particles are transferred into the upper manifold tube such as 30033 and all lean particles are transferred to the lower manifold such as 30024 as shown in FIG. 10 but the operation of each cycle of separation, the sequencing of valves opening and closing are similar and as shown in accordance with the sequence shown in FIG. 10iii wherein the first column represents the ending of a first cycle and the beginning of a second cycle. Following transfer of a controlled quantity of suspended fat and lean meat particles via valve C, valve C closes simultaneously with valves A and B providing a quantity of suspended ground beef particles at a pressure of approximately 300 to 320 psi. Immediately following closure of valves A, C, and B, valve D opens. This is represented by the sequence in column 2 in FIG. 10iii, in which a small quantity of liquid carbon dioxide is transferred into the mid section of separation tube 30010 which immediately increases the pressure throughout the separation tube to approximately 350 to 370 psi. This causes the compression and reduction of the size of bubbles that are present in lean beef in substantially greater numbers than in the fat particles immediately transforming the lean beef particles to a significantly greater specific gravity. Simultaneously micro bubbles that have formed on and in each fat particle are also reduced, however, since the lean particles contain substantially more water than the fat particles, less bubbles collapse and the relative specific gravity of the fat particles to the lean particles momentarily changes such that the lean particles become heavier and the fat particles relatively lighter. This produces a separation effect as seen in FIG. 10ii. The lean meat particles 30108 have separated into the lower section of manifold 30106, and the fat particles 30092 have separated into the upper section of the manifold 30090. The combined fat and lean particles are retained behind a closed valve C in manifold 30124. When the specific gravity of the liquid CO₂ is in the order of 60 to 64 lbs per cubic foot a rapid separation occurs. This rapid separation in sequence 2 occurs for a brief period but nevertheless is sufficient to separate the fat particles 30092 which float upward and the lean particles 30108 sink downward providing a gap between the two groups sufficient to allow the injection of liquid carbon dioxide via the open valve D when valve B and A are also open with valve C remaining closed. This increases the separation distance between lean particles 30108 and fat particles 30092 as seen in FIG. 10ii. When valve D is closed and valves C, B, and A are opened, this causes the combined lean meat/fat suspension to enter into the cruciform structure as seen in FIG. 10i, while at the same time expelling both fat and lean particles from the upper and lower ends of the separation tube. Not all the fat and lean particles need to be expelled from the ends, because the next cycle will remove any particles left from a previous cycle. The third sequence of the cycle shown in the table of FIG. 10iii extending for a period of about one second followed by sequence 4 which is the same as sequence 1 wherein valve D is closed. As can be seen in the table of FIG. 10iii the first sequence of each cycle is identical to the fourth sequence wherein valves A, C, and B, are open and valve D is closed. The entire cycle extends for a period of 8 seconds and is repeated continuously. The specific gravity of the fluid which carries the frozen beef particles in suspension remains fairly constant at about 62 lbs per cubic foot and the specific gravity of the fat particles is in the order of 55 lbs per cubic foot and remains fairly constant. However, the specific gravity of the lean particles which have been buoyed by the presence of micro bubbles steadily increasing in size due to a steady increase in temperature is instantly increased by the increased pressure throughout the separation conduit and the specific gravity of the lean particles increased to its normal condition of approximately 66 lbs per cubic foot. In this way, the separation occurs rapidly as shown in FIG. 10ii with the injection of clear liquid carbon dioxide injected from conduit 30100 via conduit 30102 with valve D open such that the fluid rapidly advances in the direction shown by arrows such as 30104 and 30098. It should be noted that conduit 30094 is the same as conduit 30068 of FIG. 10i and when the sequence of valve operation as shown in FIG. 10iii is continued with the four sequences of a single cycles shown in columns 1, 2, 3, and 4, the separation of the fat from lean results in accumulation of lean particles shown as 30106 in FIG. 10ii and fat particles shown as 30092 accumulated at the upper region of the mid section 30094 of separation conduit 30010 of FIG. 10.

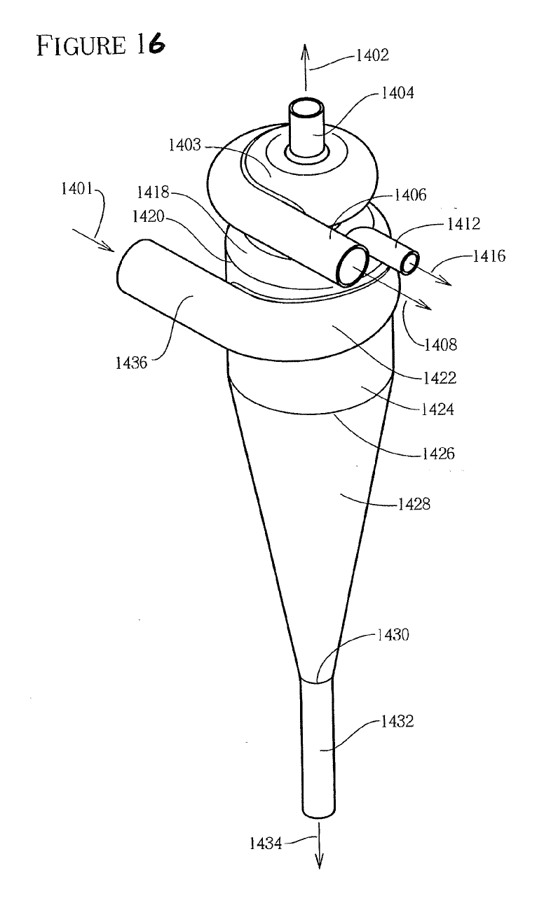

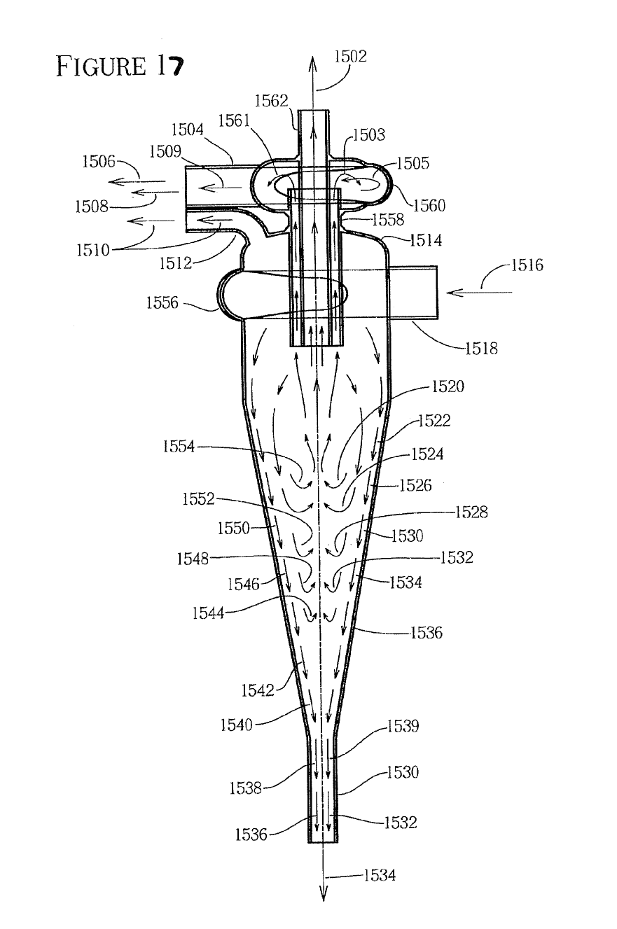

Referring to FIGS. 16 and 17, two enclosed views are provided of a pressurized hydrocyclone which can be constructed to provide yet another embodiment wherein the apparatus can be devised for continuously separating lean beef, beef fat and carbon dioxide from a fluid stream that includes all three components. The enclosed and pressurized hydrocyclone comprises a uniformly proportioned, centrally disposed enclosure having a lower segment profile similar to that of a steep inverted cone, typically having a circular profile cross section through the horizontal plane profile, an input port for accepting a fluid stream and at least three (desirably at least four) output ports for transferring the separated components (i.e., beef fat, lean beef and carbon dioxide) out of the hydrocyclone. The hydrocyclone effects a density-based separation of the solid (and liquid) components when suspended in a fluid, wherein such a fluid stream entering close to the upper end and at a tangential orientation relative to the circular cross section of the hydrocyclone body, thereby accelerating the stream as it descends through the decreasing diameter (radius) of the steep cone, forcing the heavier components toward the walls of the hydrocyclone and the lighter components toward the middle of the enclosed space within the hydrocyclone. Thus, heavier components exit the cyclone through an output port at, or toward, the bottom of the hydrocyclone cone shaped segment, while lighter components exit the hydrocyclone through output ports located at, or toward, the top of the hydrocyclone body. In some embodiments, the fluid stream is pumped into the input port of the hydrocyclone (e.g., using a suitably sized centrifugal pump), which is in communication, via a sealed connection, with a grinder, which is itself in communication, via a sealed connection, with a source of beef, such that a continuous stream of beef is ground prior to entering the input port. The ground beef is combined with pressurized carbon dioxide to form a suspension of beef particles in the carbon dioxide. The suspension may be transferred into the input port of the hydrocyclone in a controlled, continuous stream at a velocity and rate of mass flow most suited to the hydrocyclone apparatus. The source of beef is desirably, but not necessarily, any suitable quantity of 50's, 65's, or even 75's (50%, 65%, and 75% lean meat) boneless beef but most preferably that grade of boneless beef that yields the most lucrative, proportional quantities of fat and lean beef derived from the selected source.

An illustrative embodiment of a hydrocyclone having four output ports and a means for separating lean beef from beef fat using the apparatus is illustrated in FIG. 16, which represents a three-dimensional view of the apparatus, and FIG. 17, which shows a cross-sectional view of the apparatus. As shown in these two figures, the hydrocyclone has a main body that includes an upper section 1424 having generally parallel side walls and an upper wall 1514, and a lower section 1428, 1534 having a generally conical longitudinal cross-section. The upper and lower sections may be connected by a continuous annular weld 1426. The hydrocyclone further includes at least one tangential input port in communication with an input conduit 1436 through which a continuous stream of fluid with suspended lean meat and fat particles may enter the upper section of the body of the hydrocyclone. A first output port 1434, 1530 in communication with and concentric to the lower end of the lower section of the hydrocyclone body is also provided. The first output port 1530 is concentric with the body of the cyclone and may be connected to the body of the cyclone by a continuous annular weld 1430. The hydrocyclone includes three additional output ports disposed above the upper section of the body. The second output port 1404, 1562 extends upwardly from the interior of the hydrocyclone and is concentric to the hydrocyclone body and is disposed opposite the first output port 1432, 1530, such that the first and second output ports share a common center line. A third output port 1412, 1512 extends upwardly and outwardly from the top wall 1514 of the upper section of the body of the hydrocyclone. Finally, a fourth output port 1406, 1504 extends outwardly from the centerline of the hydrocyclone and is in communication with the body of the cyclone through a neck section 1558 connected to the upper wall 1514 of the upper section of the body. The neck is an annular section surrounding the second port 1562 and leads to a volute section 1560 into which the neck section 1558 empties, such that the second port 1562 passes through the center of the neck 1558.

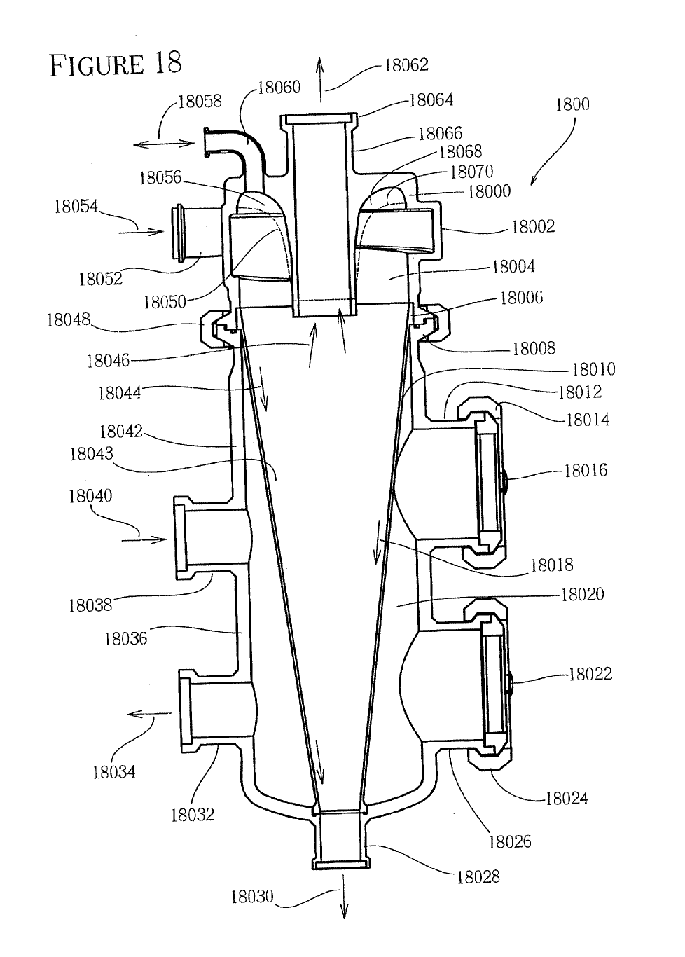

Referring to FIG. 18, a cross section through a partially enclosed cyclone 1800 is shown wherein a cyclone upper member 18000 with volute 18002 and inlet conduit 18052 is clamped to an enclosed lower cyclone member 18010 made from a suitable glass or otherwise transparent cone manufactured from any suitable material which is encapsulated by an outer pressure vessel 18042 with space 18020 which is filled with a suitable fluid, such as liquid carbon dioxide, and used to transfer heat to or, alternatively, away from the lower cone-shaped member 18010 of the cyclone. Inlet and outlet conduits 18038 and 18032 are arranged with s-line clamping rings to enable the transfer of above said fluid into, in the direction shown by arrow 18040, the space 18020 and into direct contact with the outer surface of lower cone member 18010. Such fluid transferred therein, for the purpose of controlling the temperature of lower member cone 18010 and the contents thereof.

A heavy solids extraction port 18028 provides a suitable port facilitating the removal of the more dense solids (i.e., lean meat) separated from the stream of suspended solids such as ground beef in a stream of liquid carbon dioxide, and then carried into the space within the lower cone, by a medium such as liquid carbon dioxide. Two other access ports, 18012 and 18026 with conduit are extend outwardly from pressure vessel 18042 and are capped with transparent lens caps 18016, 18022 for viewing the interior of lower cyclone member 18010. The lens caps are fitted with ring-clamping seals 18014 and 18024.

Referring again to FIG. 18 a fluid of suspended solids such as liquid carbon dioxide and ¼″ diameter particle ground beef is transferred into conduit 18052 from a blender and pump station in the direction shown by arrow 18054 through volute 18002 and then downward into the lower cone profiled member of the cyclone. The most-dense solids can be carried away from the cyclone via conduit 18028 in the direction shown by arrow 18030.

Viewing lenses at 18016 and 18022 are provided to enable the flow pattern of solids and suspension fluids to be visible there through and studied for optimization of the system. A temperature and pressure controlled liquid such as liquid carbon dioxide is provided to fill space 18020 around the cone profiled lower cyclone member 18010. The pressure of the in-space liquid must also be maintained at a pressure substantially equal to that pressure within the internal space of the transparent cyclone, which is also controlled.

Most dense solids (i.e. lean beef) separate from the fat component of ground beef and two streams comprising a first stream of lean ground beef particles and liquid carbon dioxide or carbonic acid pass through conduit 18028 and in the direction shown by arrow 18030; a second stream of lower density fatty adipose tissue suspended in fluid is extracted after following the general path indicated by arrows such as 18046 and 18062 then passing through opening at connection ring 18064 in conduit 18066.

After entering the cyclone at conduit 18052 the fluid, with suspended solids, is transferred therein following the general path shown by arrows such as 18046. A liquid free zone 18056 and 18068 has as an objective the ability to absorb fluctuations or undulations of the liquid so as to assure proper operation of the hydrocyclone. For instance, as liquid flow increases or decreases creating expansion and/or contraction of the liquid, a liquid free zone remains above the liquid, which is to provide for proper operation of the hydrocyclone. The liquid-free zone 18056 and 18068 is generally filled with a gas to absorb fluctuations in the liquid.

A small conduit 18060 is installed to help the separation process by providing suitable gas at the correct density. An annular space 18056 and 18068 defined by a broken lines 18050 and 18070 and the underside of the upper cyclone housing 18000 is filled with carbon dioxide gas, transferred via conduit 18060 in the direction shown by arrow 18058, and maintained at a selected pressure and controlled density (and temperature). Gas transferred into space 18068 may be at any suitable temperature and pressure such as at 60° F. and 298 psi or more or less, when the inlet pressure of the stream of suspended solids in liquid carbon dioxide transferred into volute conduit 18052 in the direction shown by arrow 18054 at 304 psi or more or less. In any event, the gas provided in annular space 18068 will be delivered via conduit 18060 at a pressure and temperature so as to not interfere with the controlled inlet flow of the liquid stream transferred via volute conduit 18052 in the direction shown by arrow 18054 while also inhibiting the production of carbon dioxide vapor within the stream of liquid carbon dioxide at any point within the cone shaped lower cyclone member 18010. Production of vapor within the lower cone profiled (or upper member 18000) cyclone member 18010 can also be inhibited by providing a temperature (and pressure) controlled liquid medium (preferably liquid carbon dioxide) in space 18020 wherein the temperature of medium provided in space 18020 is lower than the temperature of fluid within the hydrocyclone in space 18004 and 18043. The temperature on the inside of hydrocyclone at location 18004 may be at 4° F. or more or less and the temperature at location 18020 may be 0° F. or, most preferably, less. The temperature and pressure of the medium in space 18020 may be adjusted or controlled to prevent or minimize the production of gas or on the process side of the cyclone member 18010, i.e., within the V-shaped cone. A method is provided for controlling the temperature and/or the pressure within the space 18020 to prevent any formation of vapor along the entire length and on the inside of the V-shaped section.

Carbon dioxide gas, which has been temperature adjusted to about 40° F. or less or more can be transferred via conduit 18060 and into annular space 18056 and arranged such that the gas will precipitate when in contact, at the surfaces shown by broken lines 18050 and 18070, with the much colder (about 4° F. or less or more) fluid in space 18004. The rate of precipitation of the carbon dioxide gas can be arranged to equilibrate such that a constant mass flow rate of said carbon dioxide gas transferred into annular space 18068 via conduit 18060 will precipitate and the equilibrium will be maintained by providing carbon dioxide gas at a constant rate of flow controlled by a suitable regulator via a suitable heat exchanger. In this way a constant controlled pressure can be applied to the surfaces shown by the broken lines 18070 and 18050 thereby inhibiting the production of vapor within the fluid in space 18004; such vapor production is undesirable because it renders the purpose of the apparatus shown in FIG. 18, (i.e. the intended cyclone separation process) ineffective.

The stream of fluid (liquid carbon dioxide) and suspended matter comprising solids of varying specific densities (fatty adipose tissue and lean beef in particulate ground, separate condition) provided into space 18004 can be divided into two subsequent streams wherein a first higher density matter will separate and be transferred in the direction shown by arrows 18044, 18018 and 18030 through extraction conduit 18028 at the bottom of the hydrocyclone vessel and the lower density matter will separate and be transferred in the direction shown by arrows 18046 and 18062 through extraction conduit 18066 at the top of the hydrocyclone vessel.

Referring now to a process for separating the beef fat, lean beef and carbon dioxide from a fluid stream containing beef solids (e.g., boneless, ground beef) suspended in fluid carbon dioxide may be described as follows. The suspension may be prepared by blending together the ground beef with liquid carbon dioxide pressurized at least about 350 psia to 380 psia (e.g., 480 psia to about 600 psia) and maintained at about 34° F. (e.g., about 32° F. to 38° F.) in proportions of approximately one part ground beef to four or five parts carbon dioxide to provide a well formed suspension of solid beef components and a liquid carbon dioxide component. The suspension is continuously pumped into input conduit 1436, 1518, as represented by arrows 1401 and 1516. Inside the body of the hydrocyclone, the denser lean beef particles tend to migrate toward the walls of the body of the cyclone, traveling in a downward direction and exiting the hydrocyclone through the first output port 1432, 1530 in the direction shown by arrows 1434 and 1534. The path of the lean beef particles is represented by arrows 1522, 1526, 1530, 1534, 1550, 1546, 1542, 1540, 1538, 1539, 1536, and 1532. The less dense beef fat particles migrate toward the center of the hydrocyclone, initially in a downward direction, before turning upward, and exiting through the third output port 1412, 1512 or the fourth output port 1406, 1504. The path of the beef fat particles is represented by arrows 1520, 1524, 1528, 1532, 1544, 1548, 1552, 1554, 1503, 1505, 1561, and 1509. The carbon dioxide, being the least dense material, exits at the top of the hydrocyclone through the second output port 1404, 1562 in the direction shown by arrow 1502. The result is a separation of the fluid into three separate streams: one comprising predominantly lean beef extracted in the direction shown by arrow 1434, 1534; one comprising predominantly beef fat extracted in the direction shown by arrow 1408, 1416, 1509, 1510; and one comprising carbon dioxide represented by arrow 1402, 1502.

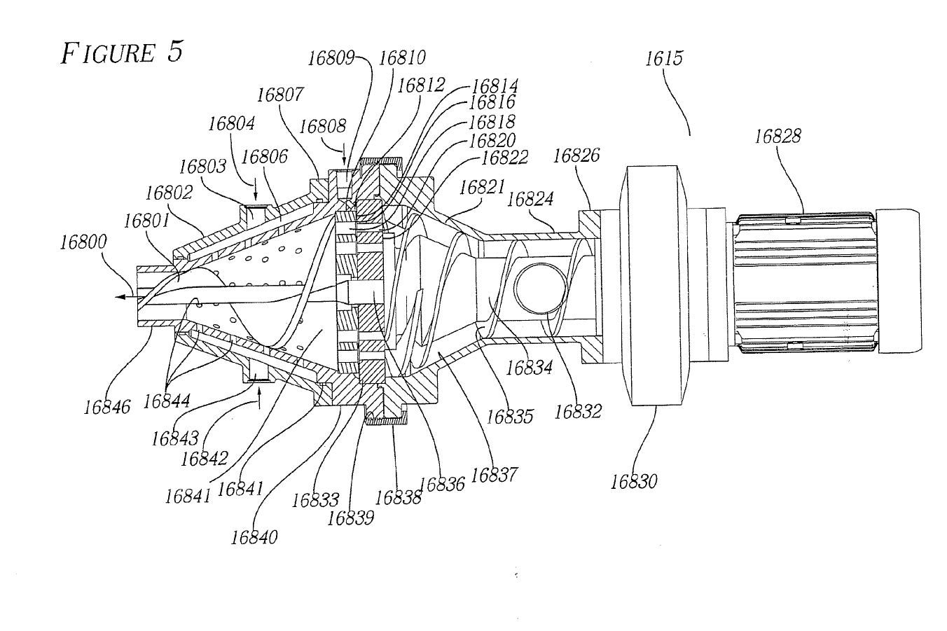

Referring to FIG. 5, a side elevation of an apparatus intended for the continuous grinding of any goods, such as boneless beef or any other meat is shown with a section cross-sectioned to assist in thorough disclosure thereof. The apparatus is intended to provide a continuous blended stream of ground meat such as ground beef blended with liquids, such as liquid carbon dioxide and/or water, in controlled proportions selected to improve performance of the centrifuge or a separator as shown in FIG. 6. Conduit section 16846 shown in FIG. 5 would be arranged to connect directly to, with or without sealed bearings as may be required, to centrally disposed shaft 9011 with the entrance to any separator as herein disclosed.

The apparatus shown in FIG. 5 is constructed of suitable materials, such as 304 stainless steel and plastic materials where appropriate, with rubberized gaskets where required to provide seals. Boneless beef is input via a port shown as 16832 in FIG. 5 is transferred under pressure by Archimedes screw 16834 through grind plate 16833 such as through grind plate aperture 16820 into aperture 16818 in plate 16810 and after blending with fluids, transferred into mixing chamber within which Archimedes screw 16801 is mounted and then via conduit 16846 in the direction shown as arrow 16800 into a centrifuge or to separator 120, as shown in FIG. 6, or to a hydrocyclone as shown in FIG. 16, or to an inclined vessel as shown in FIG. 10.

Referring to FIG. 5, a variable speed electric motor 16828 is connected directly to a gear reducer 16830 of selected ratio which, in turn, is connected to Archimedes screw member 16834. Variable speed electric motor 16828 can be adjusted by varying the electric current supplied thereto so as to vary the speed at which screw 16834 rotates thereby enabling a variable control of the mass flow of goods being transferred under pressure through port 16832 then driven by screw 16834 through grind plate 16833. The rotational speed of screw 16832 can be varied so as to adjust the mass flow of boneless beef through the grinding mechanism comprising a knife rotating with the screw against the surface of grind plate 16833 facing toward the screw and by varying the speed at which screw 16834 rotates, the knives attached thereto facilitating the cutting of meat transferred through apertures such as 16820 according to rotational speed. Boneless meat pumped through aperture 16832 and driven by screw 16834 is transferred through apertures in grind plate 16833 such as aperture 16820 at a mass flow rate controlled by the speed of variable speed electric motor 16828. Therefore, the increased rate of mass flow of beef through the grind plate is directly determined by the speed at which variable speed electric motor 16828 is driven. By increasing the rotational speed of screw 16834, boneless meat transferred through the grind plate increases correspondingly. Planetary gear reducer 16830 is attached to housing 16824 at flange 16826. An internally threaded nut 16838 matches with external thread at 16839 of member 16840 such that when nut 16838 is tightened, segment 16854 of housing 16824 is compressed against corresponding face of member 16840 adjacent to threaded section 16839. Grinding plate 16833 is clamped between member 16840 and housing 16824 so as to hold in place with a suitable compression. Grinding holes such as 16820 in grind plate 16833 are arranged to correspond with and locate centrally with an equal number of holes such as 16818 drilled in matching plate 16810 which is clamped in place by a shoulder machined in member 16840 which compresses and holds plate 16810 firmly against corresponding face of grind plate 16833. Apertures 16818 are drilled with larger diameter than the diameter of grinding holes such as 16820 in grind plate 16833. The purpose of this is to allow the free transfer of ground meat from grind apertures, such as 16820 and through adjacent apertures, such as 16818 in such a manner that there is no restriction inhibiting the transfer of ground meat through second plate 16810. Grind plate 16833 can be considered as a first plate and plate 16810 a second plate with grind holes such as 16820 corresponding with clearance holes in the second plate 16818. A series of recesses, such as 16814 and 16816, are machined in the face of second plate 16810 between the first plate and the second plate so as to provide a communication channel between holes drilled in the first and second plates. The recesses 16814 and 16816 are connected via annular passageway 16812 which is machined around the internal periphery of member 16840 at the location between the first and second plate. Annular aperture 16812 is in direct communication through a series of drilled ports and conduits with port 16809 and all such recesses and ports machined in connection with clearance holes such as 16818, end plate 16810 are in direct communication so as to allow any fluid such as liquid carbon dioxide transferred into port 16809 in the direction shown by arrow 16808 to emerge around the periphery of said holes such as 16818 in plate 16810 between plate 16810 and first grind plate 16833. In this way, pressurized liquid carbon dioxide transferred in the direction shown by arrow 16808 through port 16809 will emerge into holes such as 16818 in plate 16810 so as to cover the full circumferential surfaces of all cylindrical profile ground meat particles transferred through the holes, such as 16818 in plate 16810 to cause freezing of the ground meat particles as the particles emerge from the downstream side of the grind plate 16833. Freezing of the ground meat particles as they emerge from grinding plate 16833 facilitates the separation of particles into dense and light fractions in a separator, because the particles are prevented from freezing into larger frozen masses. In this way, ground meat processed by transfer through holes such as 16820 in plate 16833 is fully immersed in fresh liquid carbon dioxide transferred under pressure through the holes such as 16818 in plate 16810 when ground meat is transferred directly into adjacent holes such as 16818 in second plate 16810 from grind plate 16833, grinding holes 16820. The injection of liquid carbon dioxide provides a means to quickly freeze individual ground meat particles before freezing into larger masses. Particles of ground meat are transferred at a mass flow rate determined by the pressure of goods transferred through aperture 16832 and also the rotational speed of the screw 16834 driven by variable speed motor 16828. Furthermore, the particle size is also determined by the rotational speed of screw 16834 in combination with the mass flow rate pressurized and transferred through inlet port 16832. Port 16832 is connected directly with a high pressure positive displacement pump and the knives attached to screw 16834 in contact with face 16822 of grind plate 16833. By increasing the rotational speed of screw 16834 and reducing the mass flow of boneless beef through port 16832, the cut size of meat particles can be reduced. Alternatively by increasing the mass flow of boneless beef through port 16832 and reducing the rotational speed of screw 16834, the particle size of ground meat can be increased. The particle size of ground meat will affect the effectiveness of fat separated from lean in a separator, such as a centrifuge or inclined separator (FIG. 6). By reducing the particle size, the proportion of fat separated from lean can be increased. Conversely, by increasing the size of the ground meat particles, the ratio of ground meat separated from lean meat shall be altered such that less fat will separate from lean meat. Therefore, by adjusting the particle size, a specified grade of ground beef having a selected fat content can be produced. In this way, any selected fat content ground beef can be produced by varying the mass flow of boneless beef through aperture 16832 in combination with the rotational speed of variable speed electric motor 16828.

Reclaimed fluid from any separator as herein described can be recycled by control of mass flow through ports 16803 and 16843 in the direction shown by arrows 16804 and 16842. An outer member 16802 is fitted around member 16840 to provide annular cone shaped manifold space 16806. Said space 16806 is in direct communication with a series of holes such as 16844 drilled in member 16840. It can, therefore, be seen that with the apparatus herein disclosed and described in association with FIG. 16, ground beef can be blended continuously, and according to a selected proportion, with fluids transferred via ports 16803 in the direction shown by arrow 16804, port 16809 in the direction shown by arrow 16808 and into port 16843 in the direction shown by arrow 16842. Screw 16801 provided with a pitch approximately twice the pitch of screw 16834 is provided to ensure that consistent mass flow of blended ground meat and specified fluids transferred, ultimately through conduit 16846 in the direction shown by arrow 16800, are consistently blended on a continuous basis.

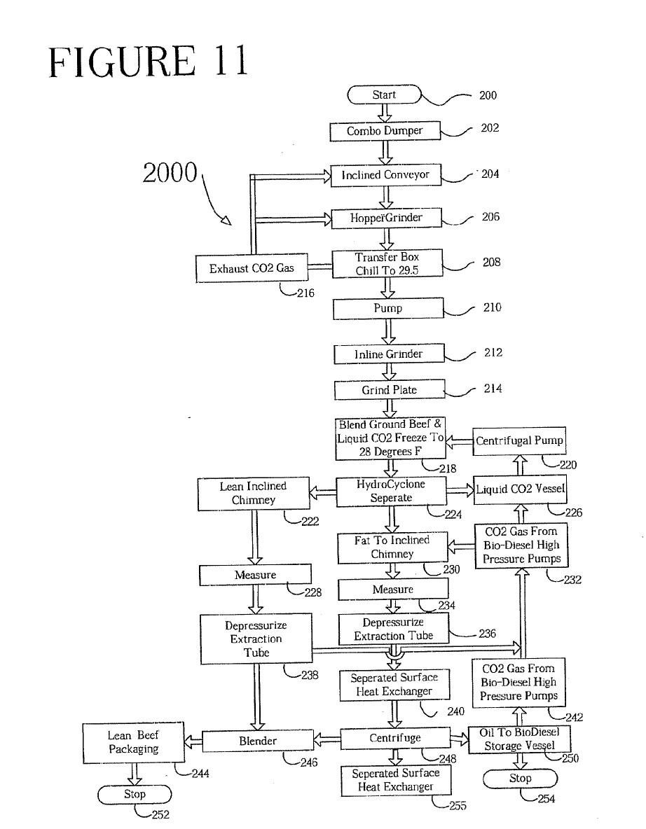

FIG. 11 illustrates a representative method 2000 in accordance with one embodiment of the present invention. Method 2000 commences at start block 200. From start block 200 the method 1000 enters block 202 which represents the loading of a material to start a process of separating fat from material. A combo dumper includes a device which seizes a container of material for offloading the container onto a conveyor, block 204. The material loaded by the combo dumper of block 202 can be any material which has a fatty substance that is to be separated to produce products that are high in lean meat or low in fat content. A representative combo dumper is shown in FIG. 3 of the present disclosure.

From block 202 the method 2000 enters block 204. Block 204 is arranged to convey the material from the combo dumper of block 202 to a hopper/grinder apparatus of block 206. A representative conveyor is illustrated in FIG. 3. Block 206 comprises a hopper flooded with carbon dioxide gas and attached at an upper side to the in-feed of a meat grinder. Block 206 of method 2000 transfers meat or beef ground to a specified particle size, such as in this instance 1″ diameter and about 1″ long, into transfer enclosure 208 (transfer box). Transfer enclosure 208 of method 2000 is arranged to provide a continuous and consistent removal of atmospheric air that may remain in the ground beef after transfer through hopper/grinder 206. Secondly transfer enclosure 208 is arranged to chill the ground beef to a specified temperature such as 29.5° F. The temperature of the stream of ground beef is maintained at 29.5° F. plus or minus 0.5 degree. The method of chilling is by direct injection of liquid carbon dioxide via carbon dioxide injectors located on the underside of the beef stream and arranged so that the liquid carbon dioxide will contact beef in the stream. The stream is blended and the liquid carbon dioxide is converted to a powdery solid which covers the particles of beef in the beef stream. A temperature probe is located in at least two positions such that at least the input temperature of the beef is measured prior to any effect other than grinding, and then the temperature of the same beef stream is measured at a point located close to the output conduit. The temperature, therefore, of beef carried through the transfer enclosure is measured at the point of entry and also the point of exit. Block 208 which is representative of the transfer enclosure, transfers a stream of ground beef having a selected particle size, chilled to a selected temperature, and said stream of ground beef is then transferred to pump 210. Block 210 represents a positive displacement twin cylinder piston pump. Block 210 representing positive displacement pump then transfers ground beef under a selected pressure into the subsequent stage of the process.

Block 208 is an apparatus that in part is used to adjust the temperature of ground beef transferred through it. The carbon dioxide used here is made available in a carbon dioxide distribution network of conduits with a central source of carbon dioxide in a tank arranged such that the liquid carbon dioxide is stored at a temperature of 0° F. Pumps are arranged to extract liquid carbon dioxide from the distribution tank and transfer a continuous stream of liquid carbon dioxide into the transfer enclosure for use therein to chill the stream of ground beef. Pumps are also made available to transfer liquid carbon dioxide to any other location where it is required for the process disclosed herein. Carbon dioxide gas is produced when the liquid carbon dioxide is at a pressure of approximately 300 psi and a temperature of approximately 0° F. is injected into transfer enclosure of block 208 and this gas is exhausted from the transfer enclosure via a suitable flexible conduit represented by block 216 and the gas is transferred through the flexible conduit of block 216 is reused by transfer into an enclosed hopper or grinder in block 206 and carbon dioxide gas can also be used within the conveying apparatus of block 204 to displace atmospheric air that may be carried with ground beef transferred there through. In this way, atmospheric oxygen in particular and also nitrogen gas are displaced by the carbon dioxide gas. In this way, carbon dioxide gas displaces substantially all air during the transfer of ground beef through the inclined conveyor of block 204, hopper/grinder of block 206 and transfer enclosure of block 208. Block 210 of method 2000 is representative of a positive displacement pump and the operating method of the positive displacement pump of block 210 has some unique features which enable it to fill any space that is contained within the cylinders thereof with carbon dioxide gas. The typical operation of pump represented by block 210 is the transfer from enclosure represented by block 208 into a cylinder with a plunger therein. Plunger of said pump is withdrawn to the pump's open position and a quantity of ground beef is transferred therein, most preferably as the plunger is withdrawn making available a particular volume substantially equal to the volume of ground beef transferred therein and when the cylinder is substantially filled with ground beef the valve through which ground beef has been supplied is closed. It is, therefore, clear that contained within the cylinder of said pump is ground beef substantially filling said pump cylinder but with an additional volume of carbon dioxide made available to ensure that pump cylinder is ready to receive additional liquid carbon dioxide. Liquid carbon dioxide is then injected into the cylinder of pump of block 210 at a pressure of approximately 380 psi or more or less ensuring that the pressure of approximately 380 psi is substantially equal to pressure within inline grinder of block 212. Various valves fitted to pump of block 210 are then closed and opened such that plunger within cylinder of pump 210 operates by filling the internal volume of cylinder in pump of block 210 and, therefore, transferring ground beef into inline grinder of block 212. A representative inline grinder of block 212 is illustrated in FIG. 5. Twin cylinders with corresponding plungers arranged in pump of block 210 operate consecutively with one cylinder filling by transfer of ground beef therein from transfer enclosure of block 208 while a second cylinder empties by the operation of a plunger filling the space within the second cylinder thereby displacing ground beef which is transferred also into inline grinder of block 212. In this way, a substantially continuous flow of ground beef can be transferred into the inline grinder of block 212. It should be noted that the particle size and temperature of the stream of ground beef transferred into inline grinder is selected so as to enable the steady grinding through a grinding plate located centrally within inline grinder of block 212. Centrifugal pump 220 transfers large volumes of liquid carbon dioxide to blend with ground beef and is maintained at a temperature of less than 28° F. and most preferably at 16° F. or also most preferably at 0° F. A stream of coarse ground beef transferred via pump of block 210 into inline grinder of block 212 and through grind plate of block 214 and into a compartment of inline grinder of block 218 where large quantities of liquid carbon dioxide transferred by centrifugal pump of block 220 into inline grinder compartment of block 218 where the ground beef and liquid carbon dioxide blend together and at the same time the ground beef having just been ground by transfer through grinding plate of block 212 will freeze to provide Individually Quick Frozen (IQF) particles of ground beef suspended in liquid carbon dioxide at a temperature of most preferably 0° F. Particle size of the ground beef will most preferably be a cylindrical shaped particle of approximately ¼″ diameter by ¼″ in length. Alternatively, the particle size of the ground beef may be of a cylindrical profile having a diameter of 3/16″ with a length of 3/16″.

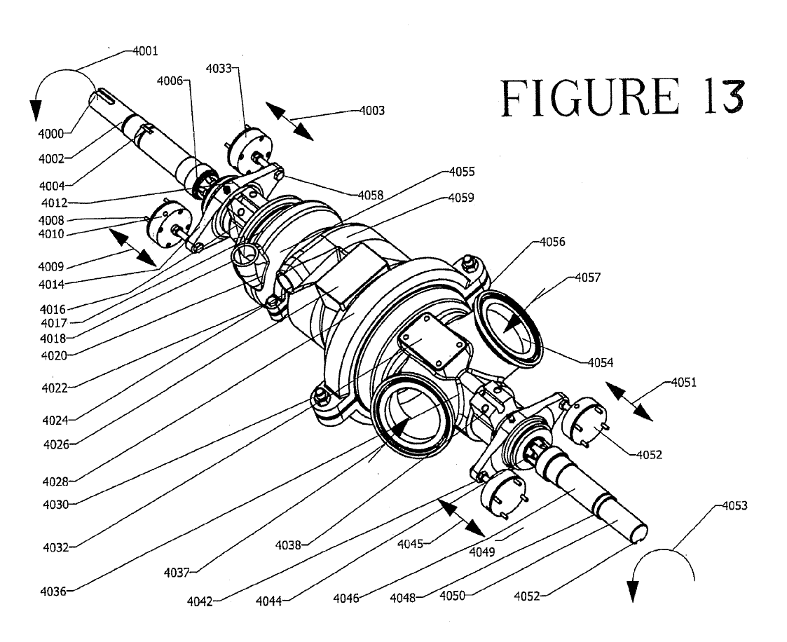

The volume of liquid carbon dioxide transferred by centrifugal pump of block 220 may comprise a continuous stream of six times the volume of the continuous stream of ground beef transferred into the mixing compartment of inline grinding apparatus of blocks 212, 214, and 218 thereby providing a continuous stream of ground beef having all particles Individually Quick Frozen and separated from each other and suspended therein which is then transferred via suitable conduit into a hydrocyclone separating apparatus of block 224. Liquid carbon dioxide in vessel of block 224 is made available according to requirements wherein a proportion of ground beef relative to the quantity of liquid carbon dioxide is 1:6. The apparatus comprising inline grinder with grind plate of block 212 and for preparing individually quick frozen particles of cut meat and fat blending compartment of block 218 is shown in FIGS. 13, 14, and 15.

Blended liquid carbon dioxide with ground beef particles suspended therein are transferred from inline grinder assembly of block 218 to hydrocyclone of block 224. Hydrocyclone separator of block 224 is arranged to separate fat particles having a specific gravity of approximately 55 lbs/cubic foot into one stream of fat particles suspended in liquid carbon dioxide and a second stream of lean beef suspended in liquid carbon dioxide is transferred into inclined chimney of block 222 while the stream of fat particles suspended in liquid carbon dioxide is transferred from hydrocyclone of block 224 to inclined chimney of block 230.

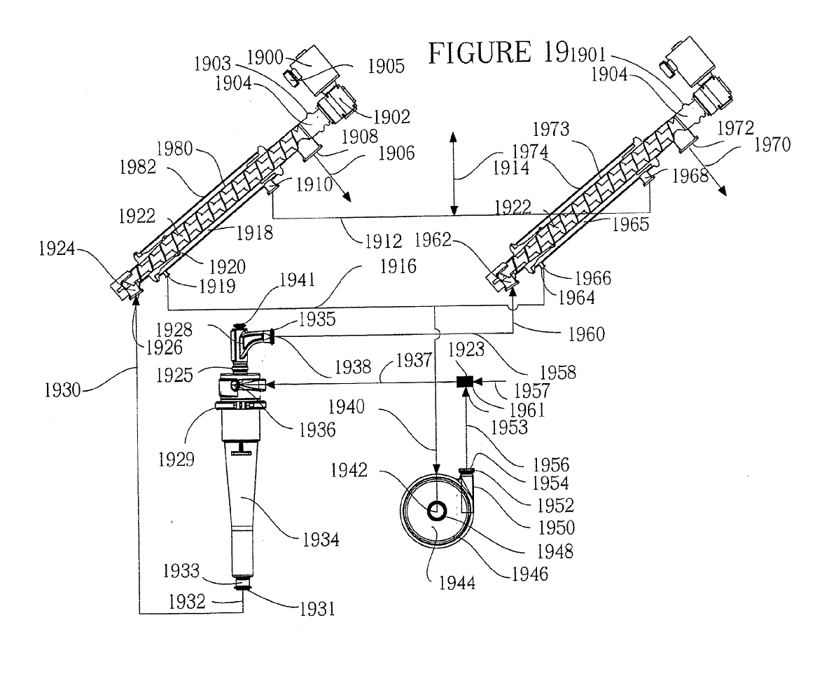

FIG. 19 herein below provides detail of the inclined chimneys for separation of fat particles from liquid carbon dioxide in a first inclined chimney shown in FIG. 19, IQF beef fat particles are separated from liquid carbon dioxide and in a second inclined chimney, IQF lean beef particles are separated from liquid carbon dioxide. It can be seen that IQF lean beef particles are separated from liquid carbon dioxide at a pressure of approximately 370 psi in inclined chimney of block 222 and IQF fat particles are separated from a second stream of liquid carbon dioxide carrying said fat particles of block 230. Liquid carbon dioxide separated from IQF lean particles in inclined chimney of block 222 is transferred to liquid carbon dioxide vessel of block 226 and liquid carbon dioxide separated from IQF fat particles in inclined chimney of block 230 is transferred also to liquid carbon dioxide vessel of block 226. IQF lean particles are transferred into a conduit which carries a stream of lean beef through a Coriolis measuring device of block 228 and then to depressurizing extraction tube of block 238. Similarly IQF fat particles separated from liquid carbon dioxide in inclined chimney of block 230 is transferred via a conduit through Coriolis measuring device of block 234 and into depressurizing extraction tube of block 236. Lean beef particles are then transferred in a continuous stream at atmospheric pressure from extraction tube of block 238 into a container which may be a blender as shown in block 246. Fat stream separated by apparatus of block 236 is transferred into a scraped surface heat exchanger or any other suitable heat exchanger of block 240 wherein the fat stream is continuously heated to approximately 118° F. and then transferred from heat exchanger of block 240 to centrifuge of block 248. Centrifuge of block 248 separates beef oil which is transferred to holding vessel of block 250 and lean particles comprising various proteins, lean beef, and collagen, which are chilled in a scraped surface heat exchanger of block 255 wherein the solids comprising lean beef, collagen, and various proteins are chilled and after suitable chilling down to a temperature of approximately 34° F., the solids are transferred to a blender of block 246 to blend with the stream of lean beef particles. Blended lean beef with lean components extracted by centrifuge of block 248 is blended with blender of block 246 then transferred through a fine grinding grinder and packaged in packaging equipment of block 244. Lean beef packaged products of box 244 are then transferred to a distribution center and the method of 2000 ends at stop block 252. Fat stream from centrifuge of block 248 is transferred to holding vessel for conversion to biodiesel in block 250 and the process 2000 is completed. The entire system excluding the combo dumper of block 202 through to packaging and including the packaging of bloc 244 is maintained substantially oxygen free and also substantially atmospheric nitrogen free by displacement using carbon dioxide which is derived from liquid carbon dioxide vessel of block 226. Carbon dioxide gas which may be recycled from biodiesel production of block 232 can be heated up to 60° F. or more prior to injection into the upper internal space of the inclined chimney of block 230 and also corresponding space in the inclined chimney of block 222. The pressurized carbon dioxide gas injected into the upper section of both chimneys is for the purpose of displacing liquid carbon dioxide, therefore, carbon dioxide gas at elevated pressure is injected into the uppermost internal free space of the inclined chimneys as shown in FIG. 19 and FIG. 7 that displaces liquid carbon dioxide and thereby inhibits the escape of liquid carbon dioxide. Crushed ice held within a suitable perforated basket or container may be inserted into the liquid carbon dioxide stream. In particular between the vessel of block 226 and the centrifugal pump of block 220. In this way, when the ice is maintained at a temperature identical to that temperature of the liquid carbon dioxide stream, water is collected from the frozen ice by the stream of liquid carbon dioxide as it passes over the surfaces of the ice particles. The process of treating liquid carbon dioxide by transferring through a conduit containing packed crushed ice enables the stream of carbonic anhydride or anhydrous carbon dioxide to become hydrated as a result of a reaction between water and carbonic hydride. When the carbon dioxide that has been in contact with the crushed ice comes in contact with beef, water is absorbed by the beef to regain moisture that beef loses through evaporation. This process is necessary to minimize and even eliminate the dehydration of ground beef particles. The duration of the exposure of the stream of lean IQF particles transferred between the hydrocyclone of block 224 after first contacting liquid carbon dioxide in the pump of block 210 and the inclined grinder of block 212 through to the separation of beef from liquid carbon dioxide in the depressurizing extraction tube of block 238 is maintained at a minimum exposure period. In this way, the beneficial anti-microbial effect of process 2000 is maintained while minimizing any weight loss due to dehydration. Therefore, it can be seen that the method 2000 provides a useful process which beneficially causes an anti-microbial effect to virtually eliminate pathogens that may be present with the processed beef.

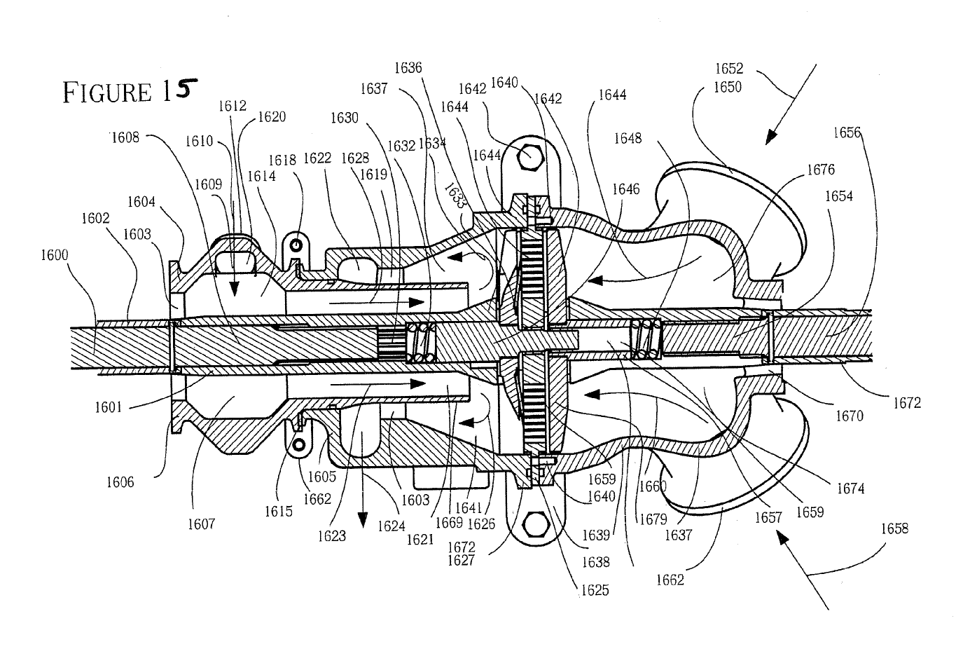

Referring now to FIG. 15 a cross sectional view of apparatus shown in FIGS. 13 and 14 is shown wherein three cast stainless steel segments of 1604 is clamped to segment 1605 by clamp 1616 acting against a ridge machined appropriately to provide rim 1615. Clamps 1616 and its opposing alternate clamp segment (not shown) are held tightly together by bolts such as 1618 thereby maintaining housing segment 1606 to segment 1605. Clamp 1638 similarly rigidly clamps housing segment 1605 via machined rim shown as 1627 and 1643 held rigidly by clamping force to ridge 1639 to third housing segment 1637. The three segments clamped together are sealed so as to enable the pressurization of spaces such as 1676, 1674, 1637, 1621, 1641, 1609, 1620, and 1607. A mechanical seal (not shown) is fitted to bushing 1602 and which is fixed rigidly to a plate covering annular section 1603 which is clamped to the rim 1604 and 1606 of housing segment 1605. Additionally, the mechanical seal is attached to a plate which seals annular ring 1670 by rigid sealed attachment to the adjacent segment of housing 1637. Two 6″ diameter inlet ports 1650 and 1662 are sealed and connected rigidly to ground boneless beef input streams flowing in the direction of arrows 1652, 1658, 1660, and 1644. The transfer of pressurized boneless beef into space 1676 and 1674 at a pressure and temperature which most suitably provides the optimal conditions for grinding with grind plate 1659 with apertures 1644 when the ground particles are forced through the holes 1644 in plate 1659. The strands of beef having spaghetti like tubular cross section are cut on both sides of the plate into particles of selected size by knives 1642 and 1636. The temperature of boneless beef transferred in the direction shown by arrows 1644 and 1660 is maintained at a suitable temperature such as 29.5° F. At this temperature beef can be ground by the apparatus shown in FIG. 15 into individually quick frozen particles and according to the method described herein. The temperature of the streams of ground beef transferred through grind plate 1659 is maintained such that while being as low as possible damage is not caused by shattering and crumbling due to the beef stream being frozen and a temperature as low as possible with sufficient margin for error must be maintained in order to achieve efficient processing. Ground beef transferred through apertures 1644 in grind plate 1659 are cut by blades in knife holder 1636. The strands of beef transferred through apertures 1644 can be cut at any selected length. Knife 1636 rotates at a controlled rate up to about 350 rpm or lower. Knife 1636 is driven by drive shaft 1646 which is spring loaded so as to clamp grind plate 1659 between the rotating knife holders 1642 and 1636. Knife 1636 rotates at a speed of approximately 300 rpm and the velocity of beef transferred through grind plate 1659 is such that the size of particles cut by knife 1636 is about ¼″ diameter by ¼″ in length while the input particles transferred in the direction shown by arrows 1652 and 1660 are 1″ diameter by 1″ in length or more. Liquid carbon dioxide is transferred at high velocity in the direction shown by arrow 1610 through volute 1612. The profile of volute 1612 at 1609 is such that when high velocity liquid carbon dioxide is pumped there through and in the direction of 1610 it rotates around space 1614 and space 1607 within the volute 1612 and continues to spin in a direction into and out of the FIG. 16 and also while moving rapidly in the direction shown by arrows 1623 and 1628. Central drive shaft 1608 is attached to an electric motor provided to drive knives 1636. A spline 1630 is arranged with a spring 1632 to provide central location of drive shaft by segment 1646 which penetrates the grind plate 1659 at a central point. Hollow shaft 1602 and 1601 extends the full length of drive shaft 1608 covering the internally located shaft and an expanded end of hollow shaft 1601 at 1619 and 1633 provides a ramped profile such that when liquid carbon dioxide traveling at substantial velocity in the direction shown by arrows 1623 and 1628 the direction is reversed following a course approximately as shown by arrows 1626 and 1634. Liquid carbon dioxide is then transferred after blasting and freezing the small beef particles as they are cut from the face of plate 1636 thereby freezing the particle independently and quickly and carrying the beef particles through annular space 1603 and 1619 and into volute 1622 and then in the direction shown by arrow 1624 into a suitably sized conduit attached to the volute with space 1622. In this way, beef particles are frozen instantly as they are transferred from the grind plate 1659 by which they were formed and after being cut to selected lengths by multi-bladed knife 1636 rotating about shaft 1646, said ground beef frozen particles are carried with the stream of liquid carbon dioxide to a separator.

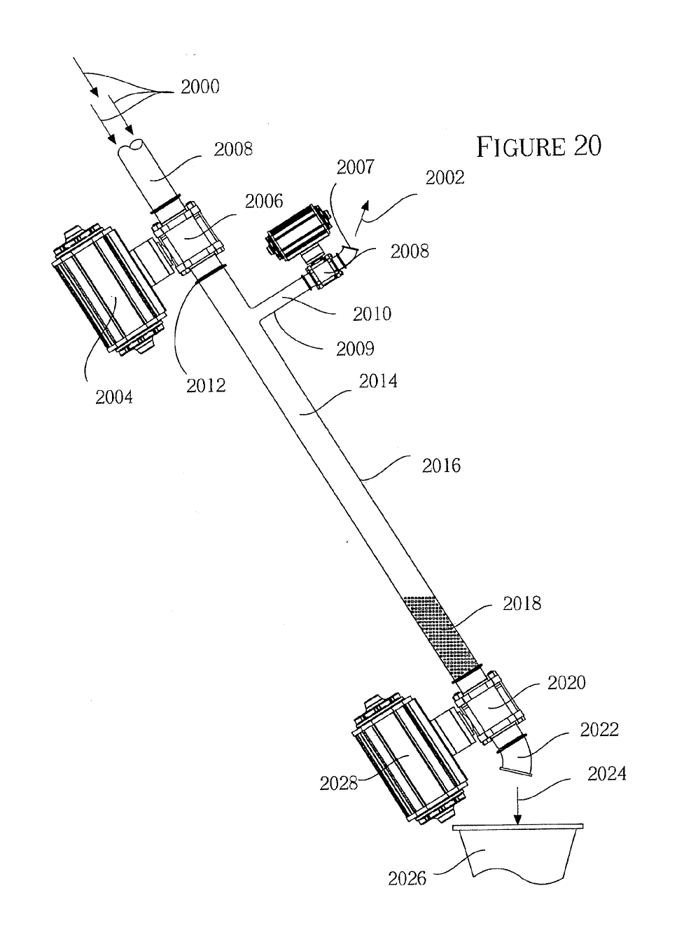

Referring now to FIG. 19 a diagram representing four pieces of equipment arranged to separate solid beef particles from liquid carbon dioxide are laid out to demonstrate one embodiment of a process for separating lean meat and fat particles. A hydrocyclone 1934 is fed via a conduit 1937 arranged to transfer a blend of frozen fat and lean particles carried in a stream of liquid carbon dioxide (or carbonic acid) from a source of ground beef 1957 and a source of liquid carbon dioxide transferred via conduit 1940 to the center 1942 of centrifugal pump 1948. Liquid carbon dioxide transferred along the conduit 1956 in the direction shown by arrow 1955 to a confluence of a stream of ground beef transferred via conduit 1957. The stream of liquid carbon dioxide and the stream of ground beef comprising frozen particles of beef combine at confluence 1923 prior to transfer along conduit 1937 and into volute 1936. Hydrocyclone 1934 separates the fat components from the lean beef components and the heavier lean beef components exit via conduit 1933 and port 1931 and are carried via conduit 1930 to inclined separator 1904. Liquid separator 1904 comprises a centrally disposed variable speed Archimedes screw 1922 driven by motor 1900 and gear box reducer 1902. Stream of liquid carbon dioxide and solid frozen lean beef particles is transferred via port 1926 and conduit section 1924 and conduit 1930 and the spaces between flutes such as 1920 of screw 1922. A perforated conduit 1980 is enclosed within a larger non-perforated conduit 1982. The perforated conduit 1980 houses the screw 1922. Liquid carbon dioxide penetrates perforated conduit 1980 and flows through annular space 1918 and through port 1919 into conduit 1916 while the solid particles of frozen lean beef are transferred along and through conduit 1980 by the rotating action of screw 1922 and then through port 1908 and in the direction shown by arrow 1906. This is enabled since pressurized temperature controlled carbon dioxide gas maintained at a slightly higher pressure than the liquid carbon dioxide which escapes through port 1919. Said temperature controlled gas is transferred into and out of port 1910 according to the level of liquid carbon dioxide in annular space 1918. An electronic process control instructs the flow of gas to change according to the height of liquid carbon dioxide above its entry point. If the liquid carbon dioxide fills the space within conduit 1982 gas pressure is increased and transferred through port 1910. If the level of carbon dioxide drops below a desired point, gas pressure in conduit 1912 is reduced. In a similar fashion to the separation of lean beef particles from liquid carbon dioxide, fat particles are carried in a stream of liquid carbon dioxide from hydrocyclone port 1935 through conduit 1960 in the direction shown by arrow thereon and into port of 1962. Fat particles are retained within centrally disposed small diameter perforated conduit 1973 while liquid carbon dioxide penetrates perforated conduit 1973 and flows along annular space 1965 downward and toward conduit section 1966 and from there out through port 1964 and through conduit 1916 followed by transfer along conduit 1940 in the direction shown by arrow and into port 1942 of centrifugal pump 1948. In this way, liquid carbon dioxide is recycled continuously and reclaimed from solids contained therein by inclined liquid separators 1904 and 1901. Solid frozen beef fat particles are carried upward by screw 1922 and then through port 1972 along conduit 1970 in the direction by the arrow shown. Gas maintained at the same pressure as provided through conduit 1914 and then along conduit 1912 and into both ports 1910 and 1968 and into spaces 1973 and 1918 and thereby maintaining the level of liquid carbon dioxide in annular spaces 1965 and 1918. Solid beef fat particles are transferred from port 1972 and into an apparatus shown in FIG. 20. Solid lean beef particles are transferred from port 1908 to a similar apparatus shown in FIG. 20.

Depressurization vessel shown in FIG. 20 comprises a conduit 2016 with large capacity ball valves 2006 and 2020 attached with clamps, such as 2012, to conduit 2016 at both ends. During operation, the frozen particles of beef 2000 (or fat) are transferred via conduit 2016 and retained by lower valve 2020 in a closed position. A conduit 2009 of smaller cross sectional area than conduit 2016 is welded in position on conduit 2016 and has a valve 2008. Spaces 2010 and 2014 are charged with high pressure carbon dioxide and beef particles 2018. With the passage of time product 2000 is carried along conduit 2008 through valve 2006 and into space 2014 and so to accumulate at the bottom of conduit at 2018. Space 2014 progressively fills with beef particles and after several minutes is substantially filled up to a level below the confluence of conduits 2009 and 2016 at which time valve 2006 is closed and the flow of beef 2000 is transferred to another apparatus assembly similar to that shown in FIG. 20. Alternate apparatus is then progressively loaded by flow of product 2000 into a conduit similar to the apparatus shown in FIG. 20. When space 2014 is substantially filled valve 2006 is closed and the gas pressure reduced to atmosphere by opening of valve 2008 which allows the escape of pressurized carbon dioxide gas through port 2007 in the direction shown by arrow 2002. Gas pressure in spaces 2014 and 2010 drops to atmospheric pressure at which time valve 2020 is opened thereby allowing product 2018 to flow downward through elbow 2022 in the direction shown by arrow 2024 and into receptacle 2026. The apparatus shown in FIG. 20 is duplicated as required for the separate streams of lean beef and of beef fat transferred from ports 1908 and 1972, respectively, of liquid separators 1904 and 1901 in FIG. 19 and typically two sets of apparatus shown in FIG. 20 are connected in parallel to port 1908 and also two sets of apparatus as shown in FIG. 20 are attached in parallel to port 1972 thereby enabling the reduction of gas pressure contained with processed beef product to that pressure equal to atmosphere thereby facilitating the transfer of product from the system. In this way, lean beef can be separated from beef fat particles and liquid carbon dioxide and beef fat particles can be separated from lean beef particles and liquid carbon dioxide.

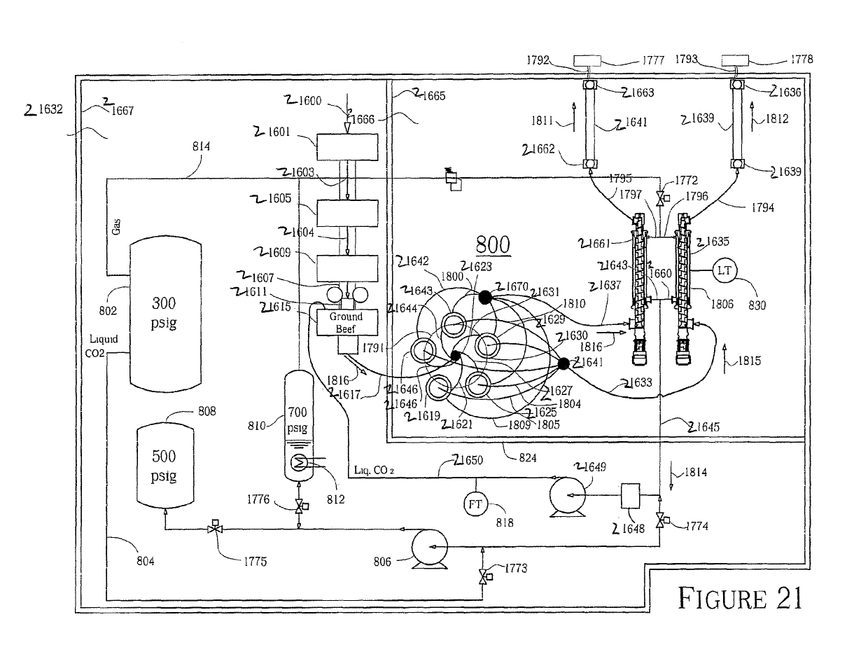

Referring now to FIG. 21 a schematic plan view of equipment laid out in a production environment is shown in diagrammatic form. A combo-dumper 21601 is arranged to empty boneless beef and boneless beef trim into the hopper of grinder shown as 21605. Bins containing fresh boneless beef are positioned into combo dumper 21601 with a fork truck and after positioning combo dumper 21601 elevates the bins and inverts them such that the contents which may weigh in the order of 1000-2000 lbs, into hopper located above primary grinder 21605. The primary grinder in this instance is arranged to grind boneless beef into coarse ground boneless beef wherein each coarse ground particle has the dimensions 1″ diameter and about 1 inch length. More particularly, the profile of each particle of the coarse ground beef comprises a cylindrical profile of about 1 inch in diameter and one inch in length. These dimensions can be varied to any suitable size, however it is important that in any given production quantity of coarse ground beef subsequently transferred into transfer box 21609 has the dimensions of not less than ½ inch diameter and ½ inch in length and up to, for example, 3 inches in diameter and 3 inches in length. The coarse ground beef is transferred into transfer box 21609 which is enclosed other than for the entrance port for ground beef which is transferred there through into transfer box 21609. Additional ports comprise an exhaust duct of any suitable length and injection ports for liquid carbon dioxide which are typically located on the lower side of the transfer box 21609. The function of the transfer box 21609 is to enable continuous operation with the removal of atmospheric gases from contact with said ground beef. The removal of atmospheric gases is achieved by displacing substantially all gases in contact with the ground beef with carbon dioxide gas which is produced from liquid carbon dioxide by absorbing heat from the ground beef thereby reducing its temperature. In this way, liquid carbon dioxide injected into the underside of the transfer box 21609 evaporates and in doing so reduces the temperature of the ground beef and displaces air which is then exhausted through a suitable exhaust duct to atmosphere. The temperature of the continuous stream of coarse ground beef transferred into transfer box 21609 is adjusted to about 29° F. or as low as 28° F. and most preferably 29.5° F., but importantly not above 32° F. The chilled stream of coarse ground beef is transferred from transfer box 21609 along an enclosed conduit 21607 and into a twin cylinder positive displacement piston pump 21611. The twin cylinders of positive displacement pump 21611 contain plungers or pistons and the positive displacement pump 21611 is arranged to transfer the continuous stream of chilled coarse ground beef into inline grinder 21615. Inline grinder 21615 is more extensively described herein in association with FIGS. 13, 14 and 15. Inline grinder 21615 is arranged to enable the transfer of coarse ground beef there through with a grind plate located centrally and knife driving motors 21613 and 21647 located at opposite ends of the inline grinder. In this way, coarse ground beef transferred from grinder 21605 and into transfer box 21609 in a continuous stream has atmospheric air removed there from and its temperature is adjusted prior to transfer under pressure of about 480 psi and into inline grinder 21615. The continuous stream of coarse ground beef is separated from atmospheric gases which are displaced by carbon dioxide gas and its temperature is adjusted to about 29° F. which is above the freezing point of beef but sufficiently low enough to enable its ease of transfer by positive displacement pump 21611 and into said inline grinder 21615. After secondary coarse grinding to say ¼ inches in diameter and length to 3/16 inches in diameter and length with inline grinder 21615, liquid carbon dioxide transferred at a suitable rate of mass flow through conduit 21650 and being pumped there through by centrifugal pump 1649, such that the coarse ground beef and liquid carbon dioxide are blended together with a ratio of approximately one part coarse ground beef and between three and ten parts liquid carbon dioxide and/or carbonic acid by weight or volume. Before liquid carbon dioxide is blended with ground beef, liquid carbon dioxide is contacted with crushed ice (frozen water) to hydrate the liquid carbon dioxide and produce carbonic acid. This has the advantage that hydrated carbon dioxide can release water molecules to the ground beef to hydrate the ground beef of water that is lost through evaporation. Additionally, carbonic acid has a bactericidal effect to rid the ground beef of bacteria and/or microorganisms. Centrifugal pump 21649 is arranged to provide sufficient liquid carbon dioxide (or carbonic acid) and with such velocity that the blended coarse ground beef and liquid carbon dioxide are propelled along conduit 21617 through column 21623 and then after dividing into five smaller streams, into one of the five hydrocyclone separators arranged equidistant from and around column 21623. Hydrocyclones are shown as 21649, 21645, 21643, 21629, and 21625, and are arranged such that each hydrocyclone is centrally located on a circular centerline shown as 21644. As can be seen in FIG. 21, five hydrocyclones are arranged to be equally spaced along a circular centerline 21644 which itself is centered on column 21623. In this way, hydrocyclones can be fed with a stream comprising a blend of one part ground beef and up to ten parts liquid carbon dioxide or carbonic acid, from a single stream transferred through conduit 21617 which connects at the base of column conduit 21623 which, in turn, divides into five substantially equal streams of liquid carbon dioxide (or carbonic acid) with a proportioned quantity of coarse ground boneless beef and into said five streams corresponding one within each of the five conduits 21621, 21627, 21631, 21644, and 21646.

Referring again to the array of five hydrocyclones shown in FIG. 21, it should be noted that hydrocyclones 21619, 21645, 21643, 21629, and 21625, can be the same as the arrangement described earlier in connection with FIGS. 16 and 17 wherein the stream of blended liquid carbon dioxide and coarse ground beef is transferred in the direction shown by arrow 1401 in FIG. 16 and into volute 1436 which is connected to any conduit such as 21621, 21646, 21644, 21631, or 21627. In each case for any of the five hydrocyclones shown in FIG. 21 wherein each hydrocyclone is arranged according to the description associated with FIGS. 16 and 17. It should be noted that five hydrocyclones are described herein in an array which comprises a fixed structure with a central column conduit 41623, connected by way of a manifold of five similar conduits to five similar hydrocyclones where conduit 41621 connects to a volute similar to that shown in FIG. 16 as 1436 and FIG. 17 as 1556 in hydrocyclone 1619. In other embodiments, fewer than five or more than five hydrocyclones can be used. Similarly conduit 21631 connects to a volute at hydrocyclone 21629 and conduit 21644 connects to hydrocyclone 21643 and 21646 to 21645 respectively. It should be noted that the array of hydrocyclones may comprise any suitable number of hydrocyclones of one or more wherein a centrifugal pump shown as 21649 is of sufficient capacity and size so as to provide a flow of liquid carbon dioxide (or carbonic acid) in a single stream via conduit 21650 which, in turn, connects with volute shown as 5010 around space 5011 in FIG. 14 or 4018 in FIG. 13 and wherein the single stream of fluid transferred via conduit 21650 under pressure at a suitable mass flow and velocity as can be delivered by centrifugal pump 21649 which blends with coarse ground beef to provide a blended stream continuously transferring from within inline grinder 21615 and through conduit 21617 which connects to the base of column conduit 21623. Connections are arranged to be substantially leak proof and providing for recirculation of fluid such as liquid carbon dioxide and/or carbonic acid which is pressurized and temperature controlled by way of any suitable means such as by way of a heat exchanger such as is shown in FIG. 21 at 21648.

It should be noted that the temperature of 29.5° F. is selected as being the lowest temperature that boneless beef can exist above its point of freezing and at which temperature it can be ground without damaging the cell structure which may otherwise result in a shattering of crystals within the boneless beef if the temperature is below 29.5° F. at coarse grinding within inline grinder 21615. The apparatus shown in FIG. 21 is therefore arranged to enable the loading of boneless beef to provide a continuous stream between combo dumper 21601 into grinder 21605 and there from into transfer box 21609 and so on. The temperature of ground beef provided in pallet sized quantities at 21601 will most preferably be at not more than 44° F. and not less than about 29° F. as preferably boneless beef transferred at this temperature into grinder 21605 is ground in a primary step (primary grinder) to produce a large particle coarse ground stream at such a temperature as will allow adjustment within transfer box 21609 to a temperature not less than 29.5° F. and when transferred through the grind plate on inline grinder 21615 as more extensively described herein below in association with FIGS. 13 through 15 upon being ground to a smaller particle size coarse ground stream such as ¼ inch diameter by ¼ inch long, the cylindrical-shaped individually quick frozen particles of ground beef are transferred individually into a stream of liquid carbon dioxide which is transferred by centrifugal pump 21649 in a stream of sufficient mass flow to facilitate the virtual instantaneous freezing of each particle of coarse ground beef immediately after transferring through the grind plate. In this way, the stream of primary coarse ground boneless beef pumped under selected pressure in the order of 480 psi to inline grinder 21615 at a temperature of about 29.5° F. and following a secondary coarse grinding the stream of primary coarse ground boneless beef having been ground again in a secondary process is transferred directly through the grinding plate and into the stream of liquid carbon dioxide or other suitable fluid which is maintained at a temperature which may be as low as 0° F. or lower, but generally between −10° F. and +20° F. In this way, the secondary coarse ground particles of beef will freeze instantly and in a manner often described as IQF (Independently Quick Frozen) and in a way that minimizes damage of the cell structure. After blending and freezing of the coarse ground beef subsequent to the secondary grinding at inline grinder 21615 the blended stream of fluid and coarse ground beef is transferred along conduit 21617 at a high velocity and elevated pressure into one of the hydrocyclones arranged in the array as shown. Separation of the fat or mostly fat particles of beef into a single stream or the substantially all lean beef into a second stream, the two resultant streams are separated into respective streams with a first stream transferred along conduit 21637 to a liquid separator and a second stream along conduit 21633 to a liquid separator. In other words, the combined stream of fluid and coarse ground beef transferred via conduit 21617 and separated into two streams by the array of hydrocyclones which, in turn, each provide two streams such as a stream in conduit 21630 or stream in conduit 21640 wherein fat particles and a portion of fluid are transferred via conduit 21630 and lean particles and a portion of the fluid are transferred through conduit 21640. As can be seen in plan view in FIG. 21 each fat stream emanating from each hydrocyclone is connected at a confluence 21670 and lean particles are transferred through a second stream such as through conduit 21640 which connects hydrocyclone 21645 to confluence of lean stream 21641. Each hydrocyclone 21619, 21625, 21629, 21643, and 21645 has similar construction to the hydrocyclone described in association with FIGS. 16 and 17. Each hydrocyclone has an input stream continuously transferred into the volute shown as 1518 in FIG. 17 with arrow 1516 showing the direction of flow. The supply stream is transferred through a conduit which is connected to the opening of volute 1518 in FIG. 17 and the connection is leak proof and sealingly connected to the input conduit shown as conduit 21627 with respect to hydrocyclone 21625 in FIG. 21. Each hydrocyclone has a similar connection and a total of five hydrocyclones with five conduits connected to each hydrocyclone such as 21621 connected to hydrocyclone 21619 wherein a stream of blended coarse ground beef and fluid is transferred under a selected pressure such as greater than 480 psi, via vertical column conduit 21623. The input stream of fluid connected to the input volute shown as 1518 in FIG. 17 is therefore divided into two subsequent streams after separation whereby a stream of substantially predominantly lean beef and a quantity of fluid is transferred in the direction shown by arrow 1534 in FIG. 17 and fat component blended with an amount of fluid is transferred from each hydrocyclone in a direction shown by arrow 1509 in FIG. 17 via conduit 1504 which connects to the conduit such as 21630 for hydrocyclone 21629 as shown in FIG. 21. The array of five hydrocyclones arranged as shown in FIG. 21 divide the continuous stream of suspended coarse ground and frozen beef particles and liquid carbon dioxide into two separate streams from each hydrocyclone, wherein each hydrocyclone divides the input stream of beef particles and fluid into a predominantly fat stream and a predominantly lean stream. All streams containing predominantly lean beef with fluid are connected to confluence 21641 and all streams predominantly of fat content with fluid are all connected at confluence 21670. In this way, it can be seen that five hydrocyclones are used in an array to divide the stream of coarse ground beef transferred via conduit 21617 into two streams ultimately transferred through conduits 21637 and 21633 wherein the stream transferred via conduit 21633 is a predominantly lean beef content stream and conduit 21637 is arranged to transfer the second stream comprising substantially beef fat and fluid. Liquid separator 21635 is arranged to separate the solid frozen particles of substantially lean beef from fluid as described herein in association with FIG. 19 for separator 1903, and liquid separator 21661 is arranged to separate the solid frozen particles of substantially beef fat from fluid as described herein in association with FIG. 19 for separator 1901. Fluid comprising liquid carbon dioxide and/or carbonic acid and/or water is transferred from separator 21635 via conduit 21660. Lean beef particles separated from fluid by separator 21635 are transferred to depressurization vessel 21639 isolated by valves 21639 and 21636 and operated as described herein in association with FIG. 20. In a similar fashion, beef fat particles are transferred via conduit 21637 into separator 21661 such that frozen particles of fat can be transferred into depressurization vessel 21641 isolated between valves 21662 and 21663 and operated as described herein in association with FIG. 20. An insulated wall 21665 contains space 21666 which is maintained at a temperature between −10° F. and +20° F. and space 21632 defined by wall 21667 is maintained at a temperature between 30° F. and 34° F.

Referring now to FIG. 13 a three dimensional illustration is provided of an inline grinder similar to inline grinder 1615 shown in FIG. 15. Arrows 4057 and 4037 indicate the direction of flow of primary coarse ground beef transferred into space enclosed by first housing 4036. In turn, orifices 4054 and 4034 are connected to corresponding conduits sealed thereto and connecting directly to a positive displacement pump arranged to pump a continuous stream of primary coarse ground boneless beef. The primary coarse ground boneless beef may comprise particles of boneless beef ground to provide particles of cylindrical shape having a diameter of about 1 inch or more or less, and about 1 inch in length or more or less. The stream of boneless primary coarse ground beef transferred into housing 4036 in a continuous stream at a pressure selected to provide a suitable operating condition which may be 480 psi or more or less. Housing 4036 which may be manufactured from 316 stainless steel is machined as required and includes an attachment pad with four attachment holes drilled and tapped as required and a large proportion opening connected via clamping ring 4028 and 4056 with nuts and bolts such as 4030 located and tightened so as to clamp the first clamping ring half 4028 to second half of clamping ring 4056. The clamping ring attached to housing 4036 clamps second housing 4026 so as to firmly locate the two housings 4036 and 4026 rigidly together. Third housing 4020 and second housing 4026 are held rigidly together by clamping means 4022. Said first, second, and third housings 4036, 4026, and 4020, are therefore connected rigidly together to provide an enclosure with input driving shaft 4046 and opposing input driving shaft 4002 are held rigidly by bearing and mechanical seal at 4038 and 4016. Shaft 4050 with keyway 4052 is arranged so as to enable connection to an electric drive motor arranged to rotate shaft 4050 in the direction shown by arrow 4051. Opposing shaft 4002 with keyway 4000 is arranged so as to facilitate connection to a second electric drive motor so as to facilitate rotation of shaft 4002 in the direction shown by arrow 4001. A grind plate is located and held rigidly by clamp 4028 and 4056 so as to separate space within housing 4036 from space within housing 4026. The grinding plate is not shown in FIG. 13 however detail is provided in FIG. 14 and FIG. 15 and each of the two faces of the grind plate are presented to facilitate the pressurized contact of a first knife holder connected to shaft 4050 with a second knife holder in contact with the second surface of said grinding plate attached to shaft 4002. Both first and second knife holders are rigidly attached to respective drive shafts 4050 and 4002 such that the grinding plate is located directly between first and second knife holders preventing contact directly between the knife holders. The arrangement is provided to facilitate the rotation of the first knife holder by shaft 4050 in the direction shown by arrow 4051 and rotation of the second knife holder attached to drive shaft 4002 rotating in the direction shown by arrow 4001. Pressure between the two knife holders is provided by two pairs of hydraulic pistons of short stroke. The first pair of hydraulic cylinders 4049 and 4052 are arranged to exert pressure against the grinding plate via the first knife holder. The first and second hydraulic cylinders 4049 and 4052 therefore can provide suitable pressure by small travel in the direction shown by double headed arrow 4051 and arrow 4045. Similarly the second knife holder attached to drive shaft 4002 is provided with a second pair of hydraulic cylinders 4033 and 4008. Cylinders 4033 and 4008 are arranged to provide movement through member 4014 to which they are connected by providing movement in the direction shown by arrows 4003 and 4009. Aperture 4018 is provided in a volute section of housing 4020 so as to facilitate the pressurized input comprising a continuous stream of fluid such as liquid carbon dioxide. Liquid carbon dioxide is therefore transferred into aperture 4018 in the volute of housing section 4020. Aperture 4024 is connected to a volute of housing section 4026, wherein an output conduit shown as 1617 in FIG. 15 allows blended secondary coarse ground beef with liquid carbon dioxide to be transferred there out from a second volute in housing section 4026.

As can now be easily understood FIG. 13 illustrates a three dimensional image of an inline grinder facilitating the input of a continuous stream of primary coarse ground boneless beef in the direction shown by arrows 4057 and 4037 enabling the secondary grinding thereof and blending with a continuous stream of fluid such as liquid carbon dioxide provided through aperture 4018. A combined continuous stream of secondary coarse ground beef with fluid is then transferred from the inline grinder to a separator, such as one or more hydrocyclones.

Referring now to FIG. 14 a cutaway view of inline grinder also shown in FIGS. 13 and 15 wherein the inline grinder is represented in one-quarter cutaway form enabling the understanding of its operation. Shaft 5000 and opposing shaft 5032 with keyways provided therein such as 5033 in shaft 5032 are arranged in direct opposition with knife holders 5015 and 5013 attached and in direct contact with a first face 5022 of a grinding plate clamp rigidly between housing 5034 and housing 5014. Suitably machined flanges clamp a peripheral ring attached at the periphery of grind plate with face 5022 wherein a clamp ring comprising two halves 5024 and 5018 held rigidly together by a pair of bolts such as 5036.

Referring again to FIG. 5 which is described in detail herein, it should be noted that in a preferred embodiment a continuous stream of medium, the content of which is listed below, is transferred into grinding head ports 16803, 16809, and 16843 in the direction shown by arrows 16804, 16808, and 16842. Boneless beef which will most preferably have been pre-ground, for example by primary grinder 1084 in FIG. 3, by pressurized transfer through a grinding plate mounted in barrel 1086 also shown in FIG. 3, is transferred through port 16832 under suitable pressure by pump such as 112 in FIG. 3 wherein the pressure can be approximately 380 psi or more or less but most preferably not more than 400 psi and not less than 350 psi. A suitable conduit connected to a pump connects with port 16832 of FIG. 5. A relatively small quantity of liquid carbon dioxide or carbonic acid blended with liquid carbon dioxide which may also include a small quantity of sodium chloride and/or sodium chlorite blended together to provide a suitable carrying medium is injected under pressure in the order of 500 psi into space such as 16837 via a port provided in housing 16824 (port not shown in FIG. 5) so as to blend with the pre-ground beef also transferred into space 16837. In this way, a small quantity of carrying medium transferred into space 16837 will blend together with the pre-ground beef and generally occupy voids that may otherwise develop in the stream of pre-ground beef transferred into spaces such as 16837 and spaces adjacent thereto. Screw 16834 is rotated at a suitable selected speed arranged to suit the transfer of pre-ground beef through grinding plate 16833. Screw 16834 with blades such as 16835 is arranged to fit within internal space of housing 16824 is also arranged such that when the screw is rotated within housing 16824, contact of the edges of screw flutes 16835 will be in close proximity to the inner surface 16821 of housing 16824 and any contact there between shall be limited to the minimum possible while maintaining a fairly tight seal such that when screw assembly 16834 is rotated at operating speed, slippage of product between outer edges of flutes 16835 and inner surface 16821 is minimized while also minimizing contact of any part of the metal assembly 16834 with any part of housing 16824. It should be noted that port 16832 as shown in FIG. 5 represents a typical location for such a port in housing 16824 and while FIG. 5 shows a cutaway cross section through some parts such as housing 16824, other components such as screw assembly 16834 and impellor 16801 are not shown in cutaway cross sectional representation. The assembly shown in FIG. 5 can be used for a stream of pre-ground beef with or without a small quantity of liquid medium maintained at a temperature, such as 29.5° F., while the carrier medium transferred into space 16806 via ports such as 16803 in the direction shown by arrow 16804 will be maintained at a much lower temperature such as 15-18° F. or lower such as 0° F. or even higher such as 22° F. The purpose of maintaining pre-ground beef stream at about 29.5° F. while the medium transferred into spaces, such as 16806, at a much lower temperature, such as 15° F., is to ensure that each particle of beef transferred through grind plate 16833 is independently and quickly frozen (IQF) thereby inhibiting the bonding with other particles of beef and fat to form clumps of several particles of ground beef and fat stuck together. Such clumps of particles will clearly create the inhibition of separation when transferred into separator such as shown in FIG. 6 or FIGS. 16 and 17 or FIG. 10. It can therefore be seen that by adjusting the temperature of a stream of pre-ground beef transferred through pre-grind transfer box 110 as shown in FIG. 4 at a temperature slightly above the point of freezing for beef when ground into small particles by passing through grind plate 16833 and then to be contacted on all surfaces of each particle with an overwhelming quantity of much lower temperature transferring medium, the particles will freeze immediately as individual particles and not clump together in groupings of frozen ground beef clumps. The method described herein in association with FIGS. 13, 14, and 15 discloses an IQF method of independently freezing each particle of beef and fat.

Referring again to FIGS. 3 and 4 it should be noted that the temperature of pre-ground beef transferred through blender 110 is adjusted to a temperature of about 15-18° F. with a tolerance of plus or minus 1 and this is achieved by injection of liquid carbon dioxide via conduit 1113 in the direction shown by arrow 1115 and through valves commonly known as carbon dioxide injectors such as 1137. The purpose of apparatus 110 described in FIG. 4 is to continuously adjust the temperature of the pre-ground primary beef transferred through the apparatus following a path wherein the pre-ground primary beef is transferred directly from grinder 1084 shown in FIG. 3 through port 1144 as shown in FIG. 4 wherein pre-ground primary beef is lightly blended by paddles such as 1118 and then removed via port 1140 by Archimedes screws 1122 all as shown in FIG. 4 at a velocity determined by the temperature of the ground beef transferred therein via port 1144 with a temperature measuring device 1119 then blended with a quantity of liquid or vapor carbon dioxide transferred via injectors such as 1137 in a quantity proportionate to the temperature of the primary ground beef in contact with a temperature measuring device. In this way, the temperature of pre-ground primary beef transferred via port 16832 and into space 16837 can be adjusted by varying the quantity of liquid/vapor carbon dioxide blended into the stream of beef. A temperature gauge measures the input temperature of pre-ground beef and the output temperature after adjusting the temperature thereof by blending vigorously with liquid/vapor carbon dioxide and measuring the temperature of the output ground beef with a temperature gauge before transferring into pump 112 as shown in FIG. 1 after transfer through port 1140. If the temperature of the input pre-ground beef to transfer box 110 is substantially higher than 29.5° F., say 38° F., a much larger quantity of liquid carbon dioxide will be blended with the pre-ground beef stream and the retention time in transfer box 110 will be extended by slowing the rotating Archimedes screws 1122. However if the temperature is fairly low, say 32° F., the quantity of liquid/vapor carbon dioxide blended into the stream of pre-ground beef transferred through transfer box 110 will be reduced and the residence time of the primary coarse ground beef retained in transfer box 110 will be reduced relative to higher temperature stream of pre-ground beef. It can therefore be seen that by increasing the quantity of liquid/vapor carbon dioxide transferred to a stream of pre-ground beef in through carbon dioxide injectors suitably located to ensure thorough contact and blending with pre-ground beef in transfer box 110, the temperature will be decreased. Conversely if the quantity of liquid/vapor carbon dioxide transferred to contact the stream of ground beef transferred, the temperature of the stream of pre-ground beef will not be as low as when the quantity of liquid/vapor carbon dioxide is greater. In this way, the input temperature of the stream of primary ground beef transferred into space 16837 of inline grinder 1615 can be adjusted to suit the process which is intended to result in IQF particles of ground beef carried in a stream of medium. In one embodiment, the inline grinder 1615 disclosed in association with FIG. 5 is rigidly mounted between a Coriolis measuring device and the input port of a separator, such as to the input ports 1238 and 1240 of separator 120 shown in FIG. 6. In another embodiment, the output conduit 16846 of inline grinder apparatus 1615 can be connected to the input conduit of volute 1436 of hydrocyclone of FIG. 16 to enable transfer of the blended output stream of inline grinder 1615.

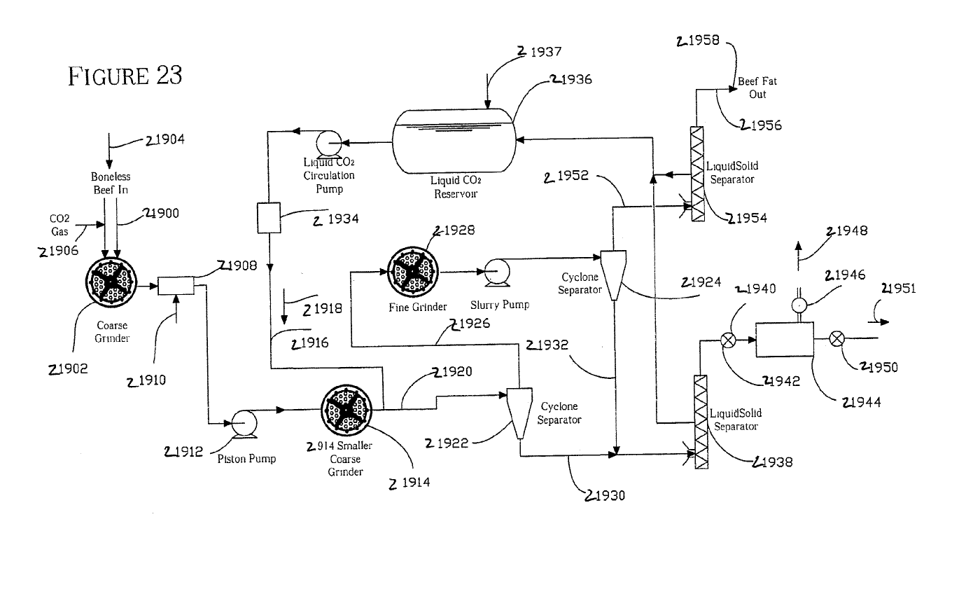

Referring to FIG. 23, in one embodiment of a method, boneless beef is transferred via conduit 21900 in the direction shown by arrow 21904 to coarse grinder 21902. Carbon dioxide gas is injected via conduit 21906 into conduit 21900 displacing substantially all air there from such that as the stream of boneless beef is transferred into primary coarse grinder 21902, wherein substantially no air and more particularly oxygen and nitrogen gases are absent. The stream of boneless beef is primarily coarse ground into particles of one inch diameter by one inch long and the stream of primary coarse ground beef is then transferred directly into transfer box 21908. Liquid carbon dioxide is injected via injector 21910 at a controlled rate such that the temperature of the stream of primary coarse ground boneless beef is reduced to between 29.5° F. and 32° F. A multiple piston pump 1912 transfers under pressure the stream of primary coarse ground boneless beef through secondary coarse grinder 21914 (inline grinder) in a continuous stream such that the grind plate of secondary coarse grinder 21914 (inline grinder) has a temperature maintained at approximately the same temperature as the stream of primary coarse ground boneless beef. In one embodiment, the secondary coarse grinder 21914 is arranged with a rotating knife on the inlet side as well as the outlet side such as inline grinder of FIG. 15, or alternatively, the process can use the inline grinder of FIG. 5. In the grinder of FIG. 15, the inlet or upstream knife rotates at approximately 100 rpm and the knife on the outside or downstream side of the grind plate of grinder 21914 rotates at approximately 300 rpm. Each rotating knife is driven by a separate electric drive motor or alternatively hydraulic drives may be used. A stream of liquid carbon dioxide maintained at 300 psi and approximately 0° F. is pumped via conduit 21916 in the direction shown by arrow 21918 such that the stream of ground beef makes contact with the liquid carbon dioxide and the ground beef is carried away from the grinder rapidly and in such a way that the smaller particles of coarse ground beef are carried in suspension along conduit 21920 directly to cyclone 21922. The particle size and temperature of the particles are factors to ensure the separation of those particles comprising substantially all fatty adipose tissue from all other particles. This is achieved by directing the flow of liquid carbon dioxide directly at and across the face of the grind plate in grinder 21914. The size of each particle is most preferably a ¼ inch diameter by ¼ inch long or maybe as small as 3/16 inch diameter by 3/16 inches long. It is important that particles freeze individually before contacting any other particles otherwise clumps of particles may freeze together inhibiting separation. FIG. 19 shows cyclone separators 21922 and 21924, however, inclined conduit separators such as those illustrated in FIG. 6 or FIG. 10 can also be used to separate the fatty particles from substantially lean particles.

Boneless beef comprises typical beef with layers of lean muscle and fatty adipose tissue of random thickness and inconsistent profile; therefore, a small particle size produced in the secondary grinder 21914 on the order of ¼ inch in diameter and ¼ inch in length will result in more complete separation of lean beef from the fatty adipose tissue. Therefore, if the objective is to produce a finished ground beef product having a lean content of between 85% and 90%, it has been found that coarse grinding to ¼ inch diameter and ¼ inch in length or perhaps a little less, followed by separation in the hydrocyclone 21922 to produce a lean beef fraction from the bottom line 21930 and a beef fat fraction from a top line 21926, followed by the fine grinding of the beef fat fraction 21926 by fine grinder 21928 and a second separation in hydrocyclone 21924 into a second lean beef fraction in line 21932 and beef fat fraction in line 21952 will result in the desired percentage of lean in the finished ground beef after the lean beef fraction of line 21930 is combined with the lean meat fraction of line 21932. The process of grinding the fat stream separated in separator 21922 and separating the fine ground fat stream in separator 21924 and then combining the first lean stream transferred via conduit 21930 with the second lean stream transferred via conduit 21932 provides for the production of a lean content ground beef of between 85% and 90% lean beef which is then separated from the liquid carbon dioxide in liquid separator 21938 to produce lean ground beef via conduit 21940 which is transferred through valve 21942 into depressurization vessel 21944 until filled to a desired level at which time valve 21942 is closed and regulator 21946 is opened to allow escape of carbon dioxide gas in the direction shown by arrow 21948. When the internal pressure of vessel 21944 is lowered to atmospheric pressure, valve 21950 is opened and the contents of vessel 21944 fall through valve 21950 and into a container of any suitable type. It should be noted that the orientation of vessel 21944 in a vertically disposed position and wherein valve 21950 has a diameter similar to the cross section of vessel 21944 will allow the relatively heavy ground beef product fall from the depressurization vessel without any other means of removal apart from the force of gravity. Other vessel arrangements can be used wherein product can be removed from vessel 21944 by means of a suitable Archimedes screw or positive displacement pump of any suitable type. Fat stream transferred via conduit 21952 and through liquid separator 21954 can be transferred into atmosphere through conduit 21956 and restricted orifice 21958 providing sufficient control during the extraction of the fat stream there through.

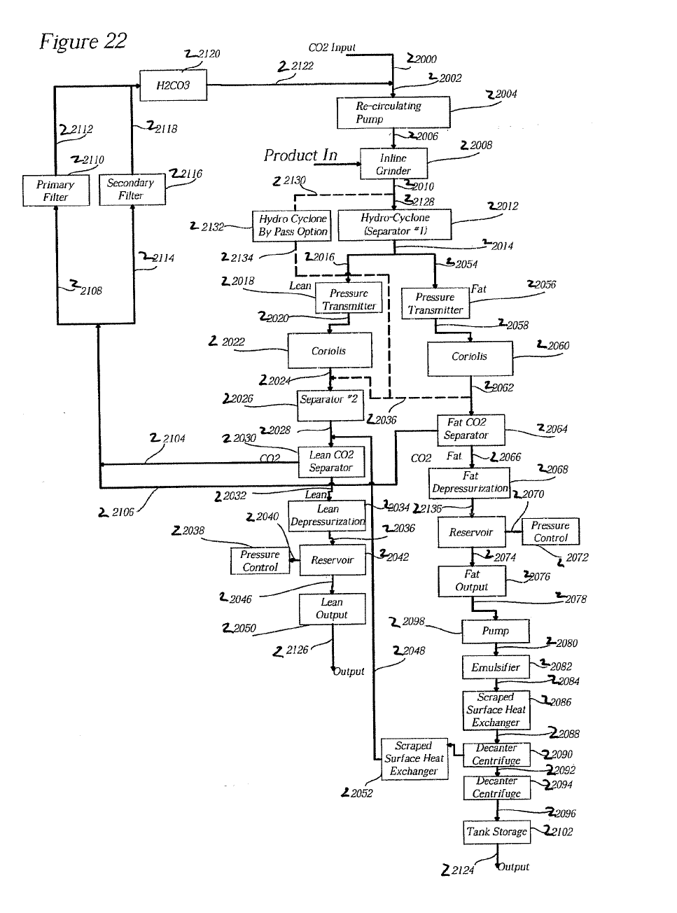

Referring to FIG. 22, a flow diagram of a method in accordance with one embodiment of the present invention is illustrated.

Carbon dioxide enters line 22000. From line 22000, carbon dioxide is combined with carbonic acid coming from block 22120 through line 22122. Liquid carbon dioxide in line 22000 is combined with carbonic acid in line 22122 and introduced into recirculating pump block 22004 via line 22002. From recirculating pump 22004, the method enters block 22008, via line 22006. Liquid carbon dioxide and carbonic acid are carried via line 22006 into the inline grinder, block 22008. Ground beef is fed into inline grinder via the Product In line. From inline grinder, block 22008, the method enters the hydrocyclone block 22012, or any other suitable separator described herein. A bypass option is provided via the broken line 22130 to a hydrocyclone bypass option, block 22132. From block 22012, all separators create at least two streams, a lean meat stream and a beef fat stream. The lean meat stream passes through line 22016 into block 22018. Block 22018 is a pressure transmitter. From pressure transmitter, block 22018, lean meat passes into a measuring device, block 22022. A suitable measuring device is known under the designation of Coriolis. From the measuring device, block 22022, the method enters a liquid separator, block 22026. The liquid separator block 22026 can be any separator to separate liquid carbon dioxide and/or gas from the lean meat. From block 22026, the method enters block 22030. Block 22030 is for lean beef/carbon dioxide separation. Carbon dioxide separated from block 22030 passes through line 22104 to a pair of filters, blocks 22110 and 22116. From primary and secondary filters, carbonic acid passes through lines 22112 and 22118 into the carbonic acid block 22120. Returning to block 22030, lean meat passes into the lean meat depressurization block 22034. Block 22034 is for bringing the pressure from an elevated pressure down to atmospheric pressure. From block 22034, lean meat passes through a reservoir, block 22042. From block 22042, lean meat passes through line 22046 and into lean meat output measuring device, block 22050, via line 22126. Pressure control, block 22038, may be a valve that releases any pressure created in reservoir, block 22042.

Returning to block 22012, the fat stream passes through line 22054 into a pressure transmitter, block 22056. From block 22056, fat passes through a measuring device, block 22060. A suitable measuring device is known under the designation Coriolis. From block 22060, fat passes via line 22062 into fat/carbon dioxide separator, block 22064. Additionally, fat and/or carbon dioxide can pass after block 22060 via line 22036 into line 22024 or to line 22034 to be recycled. Line 22024 feeds separator number 2, block 22026. Line 22134 leads to hydrocyclone bypass option, block 22132.

Returning to block 22064, from block 22064, separated carbon dioxide passes via line 22106 into a primary filter 22110 and a secondary filter 22116. From block 22064, fat passes through line 22066 into fat depressurization, block 22068. From block 22068, fat passes via line 22136 into reservoir block. Reservoir block is connected to a pressure control block 22072. Gas is released via line 22070 through pressure control block 22072 to control and/or keep the reservoir at a predetermined pressure, such as atmospheric pressure. From reservoir, fat passes via line 22074 into fat output, block 22076. From block 22076, fat passes into block 22098. Block 22098 is for pumping fat into line 22080. Line 22080 leads into an emulsifier, block 22082. From emulsifier block 22082, fat passes via line 22084 into a scraped surface heat exchanger, block 22086. From block 22086, fat passes via line 22088 into a decanter centrifuge, block 22090. From block 22090, fat passes via line 22092 into a second decanter centrifuge, block 22094. From block 22094, fat passes via line 22096 into tank storage, block 22102. From the first decanter centrifuge, block 22090, fat and/or carbon dioxide may pass into a scraped surface heat exchanger, block 22052. From block 22052 fat and/or carbon dioxide may pass via line 22048 into line 22028. Line 22028 leads into the lean carbon dioxide separator, block 22030.

Beef oil harvested from any suitable ground boneless beef source material and separated from the components combination of the source, according to any procedure disclosed herein above, can be transferred directly to the bio-diesel production processing system.

One embodiment is a method for producing lean meat, the method of the first embodiment comprises obtaining boneless meat; cutting the boneless meat into particles that are individually quick frozen with liquefied gas and/or liquid carbon dioxide and/or carbonic acid and/or carbon dioxide after cutting to prevent the particles from forming larger masses; combining the frozen particles with a liquefied gas and/or liquid carbon dioxide and/or carbonic acid to form a suspension of particles in pressurized liquefied gas and/or liquid carbon dioxide and/or carbonic acid; and transferring the suspension of particles to a separator under pressure that separates the particles into a first fraction of dense particles and a second fraction of less dense particles, wherein the dense particles contain greater amounts of lean meat than the less dense particles.

The method of the first embodiment, further comprising transferring the second fraction of less dense particles to a fine grinder for grinding into fine ground particles.

The method of the first embodiment, further comprising transferring the fine ground particles to a second separator that separates the fine ground particles into a third fraction of dense particles and a fourth fraction of less dense particles.

The method of the first embodiment, further comprising combining the first fraction of dense particles from the first separator with the third fraction of dense particles from the second separator.

The method of the first embodiment, further comprising transferring the combined first and third fractions of dense particles to a fluid separator to remove liquefied gas and/or liquid carbon dioxide and/or carbonic acid, followed by depressurizing to produce lean meat at atmospheric pressure.

The method of the first embodiment, further comprising transferring the dense particles to a fluid separator to remove liquefied gas and/or liquid carbon dioxide and/or carbonic acid, followed by depressurizing to produce lean meat at atmospheric pressure.

The method of the first embodiment, further comprising transferring the less dense particles to a fluid separator to remove liquefied gas and/or liquid carbon dioxide and/or carbonic acid, followed by depressurizing to produce fat at atmospheric pressure.

Any one of the methods of the first embodiment above, wherein the separator is a cyclone, wherein the cyclone has a tangential inlet whereby the suspension is injected at a velocity to cause a centrifugal force that forces the dense particles toward the sides and bottom of the cyclone and forces the less dense particles towards the center and top of the cyclone.

Any one of the methods of the first embodiment above, further comprising contacting liquid carbon dioxide with frozen water to produce hydrated carbon dioxide and/or carbonic acid and combining with the frozen particles to form the suspension.

Any one of the methods of the first embodiment above, further comprising cutting the boneless meat by passing the boneless meat through a grinding plate with rotating cutter blades on the upstream and downstream side of the grinding plate.

Any one of the methods of the first embodiment above, further comprising adjusting the temperature of the boneless meat to a temperature in the range of 28 degrees F. to 32 degrees F. before cutting.

Any one of the methods of the first embodiment, further comprising grinding boneless meat in a primary coarse grinder before cutting.

Any one of the methods of the first embodiment above, wherein the boneless meat comprises pieces that are of an average size of about ½ inch to about 3 inches in diameter and/or length.

Any one of the methods of the first embodiment above, wherein the frozen particles are of an average size of about 3/16 inches to about ¼ inches in diameter and/or length.

Any one of the methods of the first embodiment above, further comprising treating the boneless meat with liquefied gas and/or carbon dioxide gas to adjust the temperature of the boneless meat before grinding and to prevent atmospheric gases from contacting the boneless meat.

Any one of the methods of the first embodiment above, wherein the separator is an elongated chamber, the elongated chamber comprising, an outlet for the first fraction of dense particles located at a lower end, an outlet for the second fraction of less dense particles at an upper end, an inlet for the suspension at a location between the upper and lower outlets, and an inlet for a high pressure liquid at a location between the upper and lower outlets.

Any one of the methods of the first embodiment above, further comprising, allowing suspension into the elongated chamber, allowing high pressure liquid into the elongated chamber to separate the dense particles towards the lower outlet and the less dense particles towards the upper outlet, and allowing suspension into the elongated chamber to force dense particles from the lower outlet and less dense particles from the upper outlet.

Any one of the methods of the first embodiment above, wherein the inlet for the suspension comprises a valve, the inlet for the high pressure liquid comprises a valve, the upper outlet comprises a valve, and the lower outlet comprises a valve, the method further comprising opening the valve on the inlet for the suspension to allow suspension into the elongated chamber while the valves on the upper and lower outlets are open and the valve on the inlet for the high pressure liquid is closed.

Any one of the methods of the first embodiment above, further comprising closing the valve on the inlet for the suspension and the valves on the upper outlet and the lower outlet, and opening the valve on the inlet for the high pressure liquid.

Any one of the methods of the first embodiment above, further comprising opening the valves on the upper outlet and the lower outlet, while the valve on the inlet for the suspension is closed, and the valve on the inlet for the high pressure liquid is open.

Any one of the methods of the first embodiment above, wherein the amount of liquefied gas and/or liquid carbon dioxide and/or carbonic acid is 3 to 10 times the amount of frozen particles by weight or volume.

Any one of the methods of the first embodiment above, wherein the first fraction of dense particles comprises lean meat and the second fraction of less dense particles comprises fat.

Any one of the methods of the first embodiment above, further comprising converting the second fraction of less dense particles into biodiesel.

Any one of the methods of the first embodiment above, further comprising heating the fat particles to produce oil and centrifugally spinning to separate the oil to convert into biodiesel.

A second embodiment is a method for separating cut meat particles in a suspension. The method comprising introducing a first amount of a suspension comprising cut meat particles to a chamber, wherein the particles include varying proportions of fat and lean meat; and applying a rapid increase in pressure in the chamber that causes compression and reduction of the size of bubbles that are present in lean meat in substantially greater numbers than in the fat to increase the specific gravity of lean meat relative to fat to cause those particles greater in lean meat to sink toward a lower end of the chamber and those particles greater in fat to rise towards the upper end of the chamber.

The method of the second embodiment, wherein the elongated chamber comprises an outlet for the lean meat particles located at a lower end, an outlet for the fat particles located at an upper end, an inlet for the suspension at a location between the upper and lower outlets, and an inlet for a high pressure liquid at a location between the upper and lower outlets.

The method of the second embodiment, wherein the inlet for the suspension comprises a valve, the inlet for the high pressure liquid comprises a valve, the upper outlet comprises a valve, and the lower outlet comprises a valve, the method further comprising opening the valve on the inlet for the suspension to allow suspension into the elongated chamber while the valves on the upper and lower outlets are open and the valve on the inlet for the high pressure liquid is closed.

The method of the second embodiment, further comprising closing the valve on the inlet for the suspension and the valves on the upper outlet and the lower outlet, and opening the valve on the inlet for the high pressure liquid.

The method of the second embodiment, further comprising opening the valves on the upper outlet and the lower outlet, while the valve on the inlet for the suspension is closed, and the valve on the inlet for the high pressure liquid is open.

The method of the second embodiment, further comprising introducing high pressure liquid into the chamber in the area between the particles greater in lean meat and the particles greater in fat to cause a separation therebetween.

The method of the second embodiment, further comprising introducing a second amount of suspension with particles into the area between the particles greater in lean meat and the particles greater in fat to expel lean meat particles from the chamber and expel fat particles from the chamber.

Any one of the methods of the second embodiment above, wherein the particles are frozen.

Any one of the methods of the second embodiment above, wherein the particles are on average 3/16 inches to ¼ inches in diameter and/or length.

Any one of the methods of the second embodiment above, wherein the liquid suspension comprises liquefied gas and/or carbon dioxide and/or carbonic acid.

Any one of the methods of any one of the second embodiment above, wherein the liquid suspension comprises water.

A third embodiment is a method for separating cut meat particles in a suspension. The method comprising introducing a suspension comprising cut meat particles of varying densities to the inlet of a cyclone, and the suspension is provided to the inlet at a velocity to produce a centrifugal force within the cyclone that forces the denser particles towards the sides and bottom of the cyclone and the lighter particles towards the center and top of the cyclone; and collecting the denser and lighter particles from the cyclone.

The method of the third embodiment, wherein the denser particles comprise predominantly lean meat and the lighter particles comprise predominantly fat.

The method of the third embodiment, wherein a vapor space is created above the liquid suspension in the cyclone to allow fluctuations in the flow of the suspension and/or the pressure within the cyclone.

The method of the third embodiment, wherein the temperature and/or pressure within the cyclone is controlled by introducing a gas into the vapor space of the cyclone and allowing the vapor to precipitate on the surface of the liquid.

The method of the third embodiment, wherein vapor formation of the liquid in the cyclone is prevented by controlling the temperature and/or pressure in the cyclone.

A fourth embodiment is a method for producing lean meat. The method comprising obtaining boneless meat; cutting the boneless meat into particles that are individually quick frozen with liquefied gas and/or liquid carbon dioxide and/or carbonic acid and/or carbon dioxide after grinding to prevent the particles from forming larger masses; contacting pressurized liquefied gas and/or carbon dioxide with frozen water to produce hydrated liquefied gas and/or carbon dioxide and/or carbonic acid; combining the frozen particles with the hydrated liquefied gas and/or carbon dioxide and/or carbonic acid to form a suspension of particles in pressurized hydrated liquefied gas and/or liquid carbon dioxide and/or carbonic acid; and transferring the suspension of particles to a separator under pressure that separates the particles into a first fraction of dense particles and a second fraction of less dense particles, wherein the dense particles contain greater amounts of lean meat than the less dense particles.

The method of the fourth embodiment, wherein the hydrated liquefied gas and/or carbon dioxide and/or carbonic acid transfers water to the meat.

The method of the fourth embodiment, further comprising transferring the second fraction of less dense particles to a fine grinder for grinding into fine ground particles.

The method of the fourth embodiment, further comprising transferring the fine ground particles to a second separator that separates the fine ground particles into a third fraction of dense particles and a fourth fraction of less dense particles.

The method of the fourth embodiment, further comprising combining the first fraction of dense particles from the first separator with the third fraction of dense particles from the second separator.

The method of the fourth embodiment, further comprising transferring the combined first and third fractions of dense particles to a fluid separator to remove liquefied gas and/or liquid carbon dioxide and/or carbonic acid, followed by depressurizing to produce lean meat at atmospheric pressure.

The method of the fourth embodiment, further comprising transferring the dense particles to a fluid separator to remove liquefied gas and/or liquid carbon dioxide and/or carbonic acid, followed by depressurizing to produce lean meat at atmospheric pressure.

The method of the fourth embodiment, further comprising transferring the less dense particles to a fluid separator to remove liquefied gas and/or liquid carbon dioxide and/or carbonic acid, followed by depressurizing to produce fat at atmospheric pressure.

Any one of the methods of the fourth embodiment above, wherein the separator is a cyclone, wherein the cyclone has a tangential inlet whereby the suspension is injected at a velocity to cause a centrifugal force that forces the dense particles toward the sides and bottom of the cyclone and forces the less dense particles towards the center and top of the cyclone.

Any one of the methods of the fourth embodiment above, further comprising contacting liquid carbon dioxide with frozen water to produce hydrated carbon dioxide and/or carbonic acid and combining with the frozen particles to form the suspension.

Any one of the methods of the fourth embodiment above, further comprising cutting the boneless meat by passing the boneless meat through a grinding plate with rotating cutter blades on the upstream and downstream side of the grinding plate.

Any one of the methods of the fourth embodiment above, further comprising adjusting the temperature of the boneless meat to a temperature in the range of 28 degrees F. to 32 degrees F. before cutting.

Any one of the methods of the fourth embodiment above, further comprising grinding boneless meat in a primary coarse grinder before cutting.

Any one of the methods of the fourth embodiment above, wherein the boneless meat comprises pieces that are of an average size of about ½ inch to about 3 inches in diameter and/or length.

Any one of the methods of the fourth embodiment above, wherein the frozen particles are of an average size of about 3/16 inches to about ¼ inches in diameter and/or length.

Any one of the methods of the fourth embodiment above, further comprising treating the boneless meat with liquefied gas and/or carbon dioxide gas to adjust the temperature of the boneless meat before grinding and to prevent atmospheric gases from contacting the boneless meat.

Any one of the methods of the fourth embodiment above, wherein the separator is an elongated chamber, the elongated chamber comprising, an outlet for the first fraction of dense particles located at a lower end, an outlet for the second fraction of less dense particles at an upper end, an inlet for the suspension at a location between the upper and lower outlets, and an inlet for a high pressure liquid at a location between the upper and lower outlets.

Any one of the methods of the fourth embodiment above, further comprising, allowing suspension into the elongated chamber, allowing high pressure liquid into the elongated chamber to separate the dense particles towards the lower outlet and the less dense particles towards the upper outlet, and allowing suspension into the elongated chamber to force dense particles from the lower outlet and less dense particles from the upper outlet.

Any one of the methods of the fourth embodiment above, wherein the inlet for the suspension comprises a valve, the inlet for the high pressure liquid comprises a valve, the upper outlet comprises a valve, and the lower outlet comprises a valve, the method further comprising opening the valve on the inlet for the suspension to allow suspension into the elongated chamber while the valves on the upper and lower outlets are open and the valve on the inlet for the high pressure liquid is closed.

Any one of the methods of the fourth embodiment above, further comprising closing the valve on the inlet for the suspension and the valves on the upper outlet and the lower outlet, and opening the valve on the inlet for the high pressure liquid.

Any one of the methods of the fourth embodiment above, further comprising opening the valves on the upper outlet and the lower outlet, while the valve on the inlet for the suspension is closed, and the valve on the inlet for the high pressure liquid is open.

Any one of the methods of the fourth embodiment above, wherein the amount of liquefied gas and/or liquid carbon dioxide and/or carbonic acid is 3 to 10 times the amount of frozen particles by weight or volume.

Any one of the methods of the fourth embodiment above, wherein the first fraction of dense particles comprises lean meat and the second fraction of less dense particles comprises fat.

Any one of the methods of the fourth embodiment above, further comprising converting the second fraction of less dense particles into biodiesel.

Any one of the methods of the fourth embodiment above, further comprising heating the fat particles to produce oil and centrifugally spinning to separate the oil to convert into biodiesel.

Any one of the methods of the first, second, third and fourth embodiments above, wherein the meat is animal meat.

Any one of the methods of the first, second, third and fourth embodiments above, wherein the meat is beef.

Any one of the methods of the first, second, third and fourth embodiments above, wherein the meat is beef, poultry, fish, pork or any combination thereof.

A fifth embodiment is a cutting apparatus for cutting meat. The apparatus comprising a housing that contains a grinding plate having an upstream and downstream side; a first cutting device in a first section of the housing, the first cutting device being adjacent to the upstream side of the grinding plate; a second cutting device in a second section of the housing, the second cutting device being adjacent to the downstream side of the grinding plate; a first volute and a conduit in a third section of the housing, the first volute having an inlet for a liquid and/or gas and the conduit leads from the first volute to the second section of the housing to transfer the liquid and/or gas to the second cutting device; and a second volute in the second section of the housing to remove the liquid and/or gas from the second section of the housing.

Any one of the methods of the first, second, third and fourth embodiments above, using the cutting apparatus of the fifth embodiment to cut the boneless meat.

Any apparatus as substantially shown and described.

Any method as substantially shown and described.

For the purposes of this disclosure and unless otherwise specified, “a” or “an” means “one or more.” All patents, applications, references and publications cited herein are incorporated by reference in their entirety to the same extent as if they were individually incorporated by reference.

As will be understood by one skilled in the art, for any and all purposes, particularly in terms of providing a written description, all ranges disclosed herein also encompass any and all possible sub-ranges and combinations of sub-ranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into sub-ranges as discussed above. Finally, as will be understood by one skilled in the art, a range includes each individual member.

While illustrative embodiments have been illustrated and described, it will be appreciated that various changes can be made therein without departing from the spirit and scope of the invention.

1. A method for producing lean meat, comprising:
obtaining boneless meat;
cutting the boneless meat into particles that are individually quick frozen with liquefied gas and/or liquid carbon dioxide and/or carbonic acid and/or carbon dioxide after cutting to prevent the particles from forming larger masses;
transferring a first measured stream of the frozen particles and a second measured stream of liquefied gas and/or liquid carbon dioxide and/or carbonic acid into a separator wherein the combination forms a pressurized suspension of meat particles that separates into a first fraction of dense meat particles and a second fraction of less dense meat particles, wherein the dense particles contain greater amounts of lean meat than the less dense particles.

2-24. (canceled)

25. A method for separating cut meat particles in a suspension, comprising;
introducing a first amount of a suspension comprising cut meat particles to a chamber, wherein the particles include varying proportions of fat and lean meat; and
applying a rapid increase in pressure in the chamber that causes compression and reduction of the size of bubbles that are present on lean meat in substantially greater numbers than on the fat to increase the specific gravity of lean meat relative to fat to cause those particles greater in lean meat to sink toward a lower end of the chamber and those particles greater in fat to rise towards the upper end of the chamber.

26-72. (canceled)

73. The method of claim 1, further comprising transferring the second fraction of less dense particles to a cutting device for cutting into finer particles.

74. The method of claim 73, further comprising transferring the fine particles to a separator that separates the fine particles into a third fraction of dense fine particles and a fourth fraction of less dense fine particles.

75. The method of claim 74, further comprising combining the first fraction of separated dense particles with the third fraction of separated dense particles.

76. The method of claim 75, further comprising transferring the combined and depressurized first and third fractions of dense particles to produce lean meat at atmospheric pressure.

77. The method of claim 1, further comprising removing liquefied gas and/or liquid carbon dioxide and/or carbonic acid from the dense particles, followed by depressurizing to produce lean meat at atmospheric pressure.

78. The method of claim 1, wherein the separator is a cyclone, wherein the cyclone has a tangential inlet whereby the suspension is injected at a velocity to cause a centrifugal force that forces the dense particles toward the sides and bottom of the cyclone and forces the less dense particles towards the center and top of the cyclone.

79. The method of claim 1, wherein the boneless meat comprises pieces that are of an average size of about ¼ inch to about 3 inches in diameter and/or length.

80. The method of claim 1, wherein the frozen particles are of an average size of about 1/16 inches to about ⅛ inches in diameter and/or length.

81. The method of claim 1, further comprising treating the boneless meat with liquefied gas and/or carbon dioxide gas to adjust the temperature of the boneless meat before cutting and to prevent atmospheric gases from contacting the boneless meat.

82. The method of claim 1, wherein the separator is a vertically disposed elongated chamber, the elongated chamber comprising, an outlet for the first fraction of dense particles and the second fraction of less dense particles located at a lower end, an optional outlet or inlet at an upper end, an inlet for the particles at a location between the upper and lower outlets, and an inlet for a high pressure liquid at a location between the upper and lower outlets.

83. The method of claim 82, further comprising, allowing particles into the elongated chamber, allowing high pressure liquid into the elongated chamber as a means to separate the dense particles towards the lower outlet and the less dense particles towards the upper outlet, and allowing particles from the lower outlet.

84. The method of claim 82, wherein the inlet for the particles comprises a valve, the inlet for the high pressure liquid comprises a valve, the upper outlet comprises a valve, and the lower outlet comprises a valve, the method further comprising opening the valve on the inlet for particles to allow particles into the elongated chamber while the valves on the upper outlets are open and the valve on the inlet for the high pressure liquid is closed.

85. The method of claim 1, wherein the amount of liquefied gas and/or liquid carbon dioxide and/or carbonic acid is 3 to 10 times the amount of frozen particles by weight or volume.

86. The method of claim 25, wherein the elongated chamber comprises an outlet for the lean meat particles located at a lower end, and an inlet for a high pressure liquid at a location between the upper and lower outlets.

87. The method of claim 86, wherein the inlet for the particles comprises a valve, the inlet for the high pressure liquid comprises a valve, the upper outlet comprises a valve, and the lower outlet comprises a valve, the method further comprising opening the valve on the inlet for the particles to allow particles into the elongated chamber while the valves on the lower outlets and the valve on the inlet for the high pressure liquid are closed.

88. The method of claim 87, further comprising closing the valve on the inlet for the particles and the valves on the upper outlet and the lower outlet, and opening the valve on the inlet for the high pressure liquid.

89. The method of claim 88, further comprising closing the valves on the upper outlet and the lower outlet, while the valve on the inlet for the particles is closed, and the valve on the inlet for the high pressure liquid is open.

90. The method of claim 25, wherein the liquid suspension comprises water.
